(19) United States
(12) Patent Application Publication
(10) Pub. No.: US 2025/0076797 A1
(43) Pub. Date: Mar. 6, 2025

(54) HEATING DEVICE, FIXING DEVICE, AND IMAGE FORMING APPARATUS

(71) Applicants: Yasunori ISHIGAYA, Kanagawa (JP); Keitaro SHOJI, Kanagawa (JP)

(72) Inventors: Yasunori ISHIGAYA, Kanagawa (JP); Keitaro SHOJI, Kanagawa (JP)

(21) Appl. No.: 18/796,309

(22) Filed: Aug. 7, 2024

(30) Foreign Application Priority Data
Aug. 30, 2023 (JP) 2023-139911

(51) Int. Cl. G03G 15/20; B32B 37/06; B41J 11/00

(52) U.S. Cl. CPC G03G 15/2053; B41J 11/002; G03G 15/2064; B32B 37/06

(57) ABSTRACT

A heating device includes a rotator, a heater including a main heat generating region to heat the rotator, a pressurizer including a conductive surface configured to contact the rotator to form a nip therebetween. Further, there is a charge eliminator, a contact part to contact the rotator. The charge eliminator contacts the conductive surface at a portion of the pressurizer, the portion being outside of the main heat generating region in a longitudinal direction of the heater. Further, the contact part contacts the rotator at a position corresponding to the portion in a longitudinal direction of the heater.

### CROSS-REFERENCE TO RELATED APPLICATION

This patent application is based on and claims priority pursuant to 35 U.S.C. § 119(a) to Japanese Patent Application No. 2023-139911, filed on Aug. 30, 2023, in the Japan Patent Office, the entire disclosure of which is hereby incorporated by reference herein.

### BACKGROUND

### Technical Field

Embodiments of the present disclosure generally relate to a heating device, a fixing device, and an image forming apparatus.

### Background Art

As an example of a heating device, in a fixing device mounted on an image forming device such as a copying machine or a printer, a recording medium such as paper is transported to a fixing nip between a fixing belt as a fixing member and a pressing roller as a pressing member, and the recording medium is pressurized and heated, so that an unfixed image on the recording medium is fixed to the recording medium. In such a fixing device, since the fixing operation is continuously performed on the recording medium with the toner image, the pressing roller is charged to the polarity opposite to the toner, and there is a problem such as an offset phenomenon.

On the other hand, for example, in Patent Document 1 (JP-A-2010-128298), a non-contact charge eliminating member is arranged with respect to the pressure roller, and the pressure roller is neutralized.

### SUMMARY

Embodiments of the present disclosure described herein includes a heating device (9) comprising: a rotator (20); a heater (22) including a main heat generating region (D) configured to heat the rotator (20); a pressurizer (21) including a conductive surface configured to contact the rotator (20) to form a nip (N) therebetween; a charge eliminator (37); a contact part (40c) configured to contact the rotator (20); wherein the charge eliminator (37) contacts to the conductive surface at a portion (E) of the pressurizer (21), the portion being outside of the main heat generating region (D) in a longitudinal direction of the heater (22); and wherein the contact part (40c) contacts to the rotator (20) at a position corresponding to the portion (E) in a longitudinal direction of the heater (22).

Further, embodiments of the present disclosure described herein provide a fixing device or an image forming device including the above-described heating device.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating a schematic configuration of an image forming apparatus according to an embodiment of the present disclosure;

FIG. 2 is a cross-sectional side view of a fixing device according to an embodiment of the present disclosure;

FIG. 3 is a plan view of a heater included in the fixing device;

FIG. 4 is a plan view of a heater (different from FIG. 3) included in the fixing device;

FIG. 5 is a plan view of a heater (different from FIGS. 3, 4) included in the fixing device;

FIG. 6 is a diagram illustrating a circuit to supply power to the heater;

FIG. 7 is a diagram illustrating the positional relationship between the charge eliminating member and the heater in a longitudinal direction of the heater;

FIG. 8 is a perspective view of a charge eliminating brush and its peripheral structure.

FIG. 9 is a cross-sectional side view of a fixing device showing a separator;

FIG. 10 is a front diagram showing a separator, a fixing belt and the flange;

FIG. 11 is a diagram showing a modified example of the contact portion of the separator and a fixing belt;

FIG. 12 is a diagram showing another modified example of the contact portion of the separator and a fixing belt;

FIG. 13 is a cross-sectional view showing a separator provided on the pressure roller;

FIG. 14 is a front diagram showing the separator according to FIG. 0.11, the charge eliminating brush of FIG. 0.11 and the pressure roller;

FIG. 15 is a cross-sectional side view diagram showing the constructure of another fixing device different from FIG. 2;

FIG. 16 is a front diagram showing a separator according to FIG. 15, a fixing belt and the flange;

FIG. 17 is a perspective view of a separating claw of the fixing device according to FIG. 15;

FIG. 18 is a diagram showing the plan view of a heater and the temperature distribution of the fixing belt in the longitudinal direction (arranging direction of the heat generator);

FIG. 19 is a diagram illustrating spaces of the heater of FIG. 5;

FIG. 20 is a diagram illustrating spaces each having a form different from the form of each of the spaces of FIG. 19;

FIG. 21 is a diagram illustrating separated areas of the heater of FIG. 6;

FIG. 22 is a perspective view of the heater, the first high-thermal conduction member, and a heater holder;

FIG. 23 is a plan view of the heater having a setting of the first high-thermal conduction member;

FIG. 24 is a cross-sectional side view of a fixing device according to another embodiment of the present disclosure, different from the fixing device of FIG. 2;

FIG. 25 is a perspective view of the heater, the first high-thermal conduction member, a second high-thermal conduction member, and a heater holder;

FIG. 26 is a plan view of the heater having a setting of the first high-thermal conduction member and the second high-thermal conduction member;

FIG. 27 is a schematic diagram illustrating a two-dimensional atomic crystal structure of graphene;

FIG. 28 is a schematic diagram illustrating a three-dimensional atomic crystal structure of graphite;

FIG. 29 is a plan view of a heater having a setting of the second high-thermal conduction member different from the setting of the second high-thermal conduction member illustrated in FIG. 26;

FIG. 30 is a cross-sectional side view of a fixing device according to another embodiment of the present disclosure, different from the fixing devices of FIGS. 2 and 24;

FIG. 31 is a cross-sectional side view of a fixing device different from the fixing devices of FIGS. 2, 24, and 30;

FIG. 32 is a cross-sectional side view of a fixing device different from the fixing devices of FIGS. 2, 24, 30, and 31;

FIG. 33 is a cross-sectional side view of a fixing device different from the fixing devices of FIGS. 2, 24, 30, 31, and 32;

FIG. 34 is a diagram illustrating a schematic configuration of an image forming apparatus according to an embodiment of the present disclosure, different from the image forming apparatus of FIG. 1;

FIG. 35 is a cross-sectional side view of a fixing device according to an embodiment of the present disclosure;

FIG. 36 is a plan view of the heater in the fixing device of FIG. 35;

FIG. 37 is a perspective view of the heater and the heater holder;

FIG. 38 is a perspective view of a connector attached to the heater;

FIG. 39 is a schematic diagram illustrating a setting of thermistors and thermostats; and

FIG. 40 is a diagram illustrating a groove of a flange.

The accompanying drawings are intended to depict embodiments of the present disclosure and should not be interpreted to limit the scope thereof.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

Descriptions are given of an embodiment applicable to a medium conveyor according to the present disclosure and an image forming apparatus incorporating the medium conveyor, with reference to the following figures. In the drawings, like reference signs denote like elements, and overlapping description may be simplified or omitted as appropriate. Descriptions below are given of an image forming apparatus serving as a medium conveyor according to the present disclosure, that conveys a sheet as a recording medium and forms an image on the sheet. Further, a fixing device according to an embodiment of the present disclosure serves as a heating device included in the image forming apparatus.

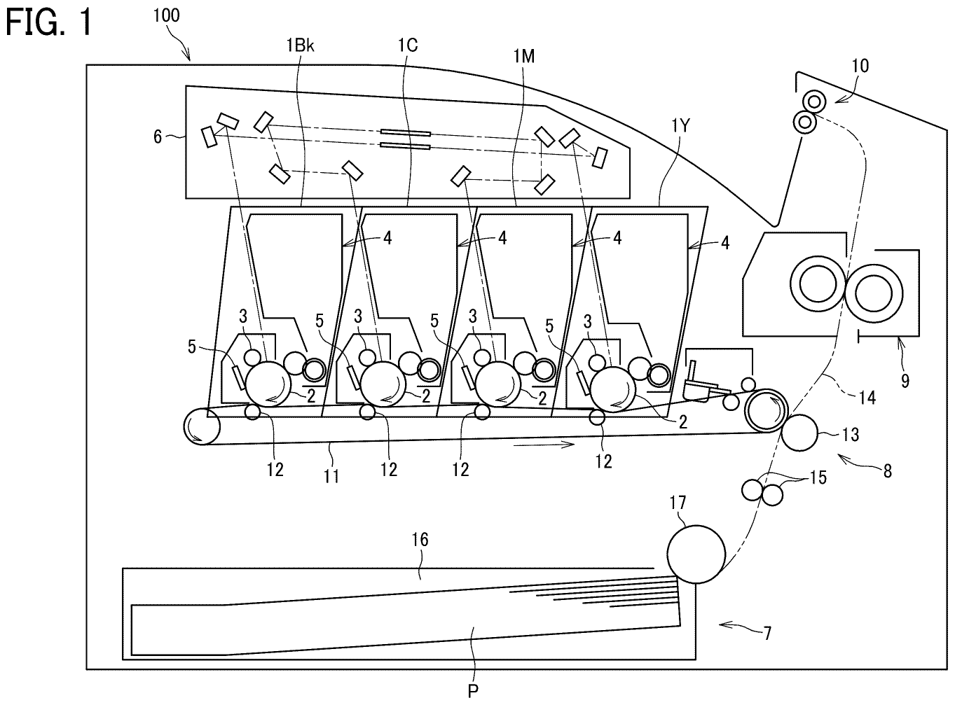

FIG. 1 is a diagram illustrating a schematic configuration of an image forming apparatus according to an embodiment of the present disclosure.

An image forming apparatus 100 illustrated in FIG. 1 includes four image forming units 1Y, 1M, 1C, and 1K detachably attached to a housing of the image forming apparatus 100. The image forming units 1Y, 1M, 1C, and 1K have substantially the same configuration except for containing different color developers, i.e., yellow (Y), magenta (M), cyan (C), and black (K) toners, respectively. The colors of the developers correspond to color separation components of full-color images. Each of the image forming units 1Y, 1M, 1C, and 1K includes a drum-shaped photoconductor 2 as an image bearer, a charging device 3 which may be implemented as a roller, a developing device 4 which may be implemented as a cartridge, and a cleaning device 5 which may be implemented as a blade. The charging device 3 uniformly charges the surface of the photoconductor 2. The developing device 4 supplies the toner as the developer to the surface of the photoconductor 2 to form the toner image. The cleaning device 5 cleans the surface of the photoconductor 2.

The image forming apparatus 100 includes an exposure device 6 which may be implemented using mirrors and one or more lasers, if desired, a sheet feeding device (also referred to as a sheet feeder) 7, a transfer device 8 which includes a belt, a fixing device 9 which includes a heater to heat a toner image, and a sheet ejection device or ejector 10 which includes at least a pair of rollers. The exposure device 6 exposes the surface of the photoconductor 2 to form an electrostatic latent image on the surface of the photoconductor 2. The sheet feeding device 7 serving as a recording medium feeder includes a sheet tray 16 and a sheet feed roller 17. The sheet feeding device 7 supplies a sheet P as a recording medium to a sheet conveyance passage 14. The transfer device 8 transfers the toner images formed on the photoconductors 2 onto the sheet P. The fixing device 9 fixes the toner image transferred onto the sheet P to the surface of the sheet P. The sheet ejection device 10 ejects the sheet P outside the image forming apparatus 100. The image forming units 1Y, 1M, 1C, and 1K, the photoconductors 2, the charging devices 3, the exposure device 6, and the transfer device 8 are included in an image forming apparatus 100 that forms the toner image on the sheet P.

The transfer device 8 includes an intermediate transfer belt 11 having an endless form and serving as an intermediate transferor, four primary transfer rollers 12 serving as primary transferors, and a secondary transfer roller 13 serving as a secondary transferor. The intermediate transfer belt 11 is stretched by a plurality of rollers. Each of the four primary transfer rollers 12 transfers the toner image from each of the photoconductors 2 onto the intermediate transfer belt 11. The secondary transfer roller 13 transfers the toner image transferred onto the intermediate transfer belt 11 onto the sheet P. The four primary transfer rollers 12 contact the respective photoconductors 2 via the intermediate transfer belt 11. Thus, the intermediate transfer belt 11 contacts each of the photoconductors 2, forming a primary transfer nip region between the intermediate transfer belt 11 and each of the photoconductors 2. The secondary transfer roller 13 contacts, via the intermediate transfer belt 11, one of the plurality of rollers around which the intermediate transfer belt 11 is stretched. As a result, the secondary transfer nip region is formed between the secondary transfer roller 13 and the intermediate transfer belt 11.

A timing roller pair 15 is disposed between the sheet feeding device 7 and the secondary transfer nip region, which serves as the secondary transfer roller 13 in the sheet conveyance passage 14. Pairs of rollers including the timing roller pair 15 disposed in the sheet conveyance passage 14 are conveyance members to convey the sheet P in the sheet conveyance passage 14.

Referring to FIG. 1, a description is given of the printing operations performed by the image forming apparatus 100 described above.

When the image forming apparatus 100 receives an instruction to start printing, a driver such as a motor drives and rotates the photoconductor 2 clockwise in FIG. 1 in each of the image forming units 1Y, 1M, 1C, and 1K. The charging device 3 uniformly charges the surface of the photoconductor 2 at a high electric potential. Then, the exposure device 6 exposes the surface of each of the photoconductors 2 based on image data of the original document read by the document reading device or print data instructed to be printed from a terminal device. As a result, the potential of the exposed portion on the surface of each of the photoconductors 2 decreases, and an electrostatic latent image is formed on the surface of each of the photoconductors 2. The developing device 4 supplies toner to the electrostatic latent image formed on the photoconductor 2, forming a toner image.

The toner image that is formed on each of the photoconductors 2 reaches the primary transfer nip region of each of the primary transfer rollers 12 due to the rotation of each of the photoconductors 2. The toner images are sequentially transferred and superimposed onto the intermediate transfer belt 11 that is driven to rotate counterclockwise in FIG. 1 to form a full color toner image. Then, the full color toner image formed on the intermediate transfer belt 11 is conveyed to the secondary transfer nip region defined by the secondary transfer roller 13 along with rotation of the intermediate transfer belt 11. The full color toner image is transferred onto the sheet P conveyed to the secondary transfer nip region. The sheet P is supplied and fed from the sheet tray 16 of the sheet feeding device 7. The timing roller pair temporarily halts the sheet P supplied from the sheet feeding device 7. Then, the timing roller pair 15 conveys the sheet P to the secondary transfer nip region so that the sheet P meets the full color toner image formed on the intermediate transfer belt 11 at the secondary transfer nip region. Thus, the full color toner image is transferred onto and borne on the sheet P. After the toner image is transferred from each of the photoconductors 2 onto the intermediate transfer belt 11, each of the cleaning devices 5 removes residual toner remaining on each of the photoconductors 2.

The sheet P transferred with the full color toner image on the surface is conveyed to the fixing device 9 that fixes the full color toner image onto the sheet P. Then, the sheet ejection device 10 ejects the sheet P onto the outside of the image forming apparatus 100, thus finishing a series of printing operations.

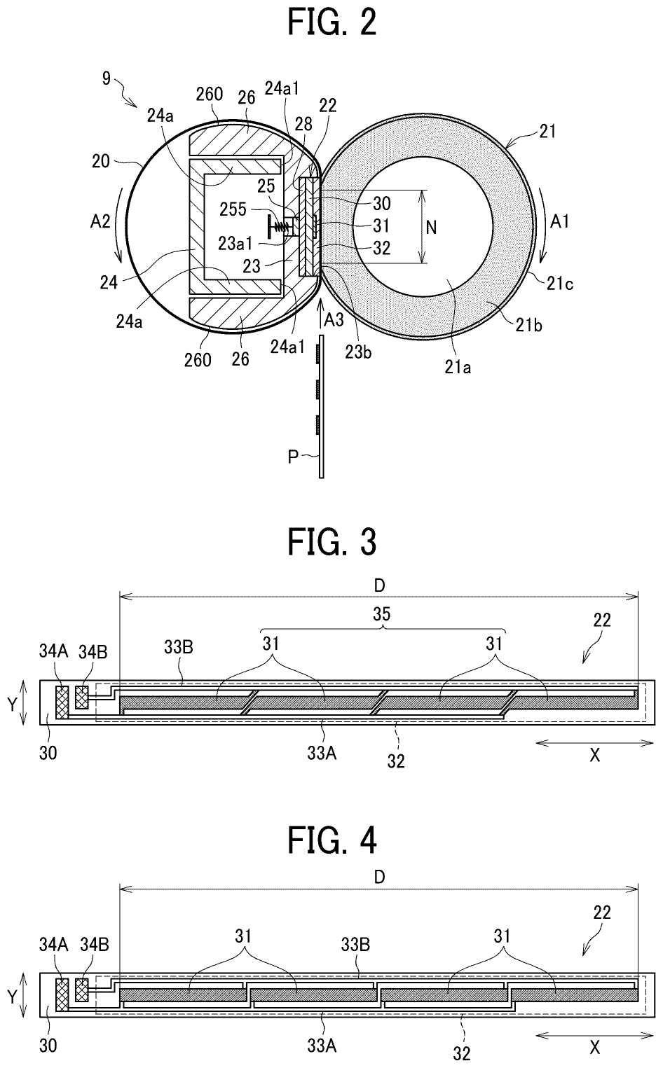

A description is given of the configuration of the fixing device 9, with reference to FIG. 2. FIG. 2 is a cross-sectional side view of the fixing device 9 according to an embodiment of the present disclosure. In FIG. 2, a charge eliminating brush and a separator are omitted from the drawing, as they are described later.

As illustrated in FIG. 2, the fixing device 9 according to the present embodiment includes a fixing belt 20 as a rotator or a fixing member, a pressure roller 21 as a counter rotator or a pressure member, a heater 22, a heater holder 23 as a holder, a stay 24 as a support, a thermistor 25 as a temperature sensor, first high-thermal conduction members 28 as a high-thermal conductivity member, a thermostat, and et al. The fixing belt 20 is an endless belt. The pressure roller 21 contacts the outer circumferential face of the fixing belt 20 to form a fixing nip region N between the pressure roller 21 and the fixing belt 20. The heater 22 heats the fixing belt 20. The heater holder 23 holds the heater 22. The stay 24 supports the heater holder 23. The thermistor 25 contacts the back face of a base 30 to detect the temperature of the base 30. A fixing rotator disposed in the fixing device is an aspect of the rotator disposed in the heating device of the present disclosure. The fixing device 9 in the present embodiment includes the fixing belt 20 serving as a fixing rotator.

The fixing belt 20, the pressure roller 21, the heater 22, the heater holder 23, the stay 24, the first high-thermal conduction members 28, and separator extend in a direction orthogonal to the sheet face of FIG. 2, in other words, a longitudinal direction. The longitudinal direction is an orthogonal direction that is a direction orthogonal to a conveyance direction in which a sheet is conveyed and parallel to the surface of the sheet. The orthogonal direction is also referred to as a conveyance orthogonal direction. The longitudinal direction is also the width direction of the sheet P to be conveyed, the belt width direction of the fixing belt 20, and the axial direction of the pressure roller 21.

The fixing belt 20 includes a base layer having, for example, a tubular base made of polyimide (PI), and the tubular base has an outer diameter of 25 mm and a thickness of from 40 μm to 120 μm. The fixing belt 20 further includes a release layer serving as an outermost surface layer. The release layer is made of fluororesin, such as tetrafluoroethylene-perfluoroalkylvinylether copolymer (PFA) or polytetrafluoroethylene (PTFE) and has a thickness in a range of from 5 to 50 μm to enhance the durability of the fixing belt 20 and facilitate separation of the sheet P and a foreign substance from the fixing belt 20. An elastic layer made of rubber (rubber layer) having a thickness of from 50 to 500 μm may be interposed between the base layer and the release layer. The fixing belt 20 according to the present embodiment may be a rubberless belt including no elastic layer. The base layer of the fixing belt 20 may be made of heat resistant resin such as polyetheretherketone (PEEK) or metal such as nickel (Ni) and steel use stainless (SUS), instead of PI. The inner circumferential face of the fixing belt 20 may be coated with PI or PTFE as a slide layer.

The pressure roller 21 having, for example, an outer diameter of 25 mm, includes a solid iron core 21a, an elastic layer 21b formed on the surface of the solid iron core 21a, and a release layer 21c formed on the outside of the elastic layer 21b. The elastic layer 21b is made of silicone rubber (rubber layer) and has a thickness of 3.5 mm, for example. Preferably, the release layer 21c is an electric conductive layer formed by a PFA with electric conductive filler such as, for example, a carbon filler added.

The pressure roller 21 is biased toward the fixing belt 20 by a biasing member such as a spring and pressed against the heater 22 via the fixing belt 20. As a result, the fixing nip region N is formed between the fixing belt 20 and the pressure roller 21. As a driver drives and rotates the pressure roller 21 in a direction indicated by an arrow A1 in FIG. 2, the fixing belt 20 is rotated along with the rotation of the pressure roller 21 in a direction indicated by an arrow A2 in FIG. 2. These directions A1 and A2 are the directions of the pressure roller 21's rotation and fixing belt 20's rotation during the image forming and fixing the toner image onto the sheet P.

The heater 22 is disposed to contact the inner circumferential face of the fixing belt 20. The heater 22 according to the present embodiment contacts the pressure roller 21 via the fixing belt 20 and serves as a nip formation pad to form the fixing nip region N between the pressure roller 21 and the fixing belt 20. The fixing belt 20 is a heated member heated by the heater 22. In other words, the heater 22 heats the sheet P that passes through the fixing nip region N via the fixing belt 20.

The heater 22 is a planar heater extending in the longitudinal direction of the heater 22 that is parallel to the width direction of the fixing belt 20. The heater 22 includes a base 30 having a planar shape, resistive heat generators 31 disposed on the base 30, and an insulation layer 32 covering the resistive heat generators 31. The insulation layer 32 of the heater 22 contacts the inner circumferential face of the fixing belt 20, and the heat generated by the resistive heat generators 31 is transmitted to the fixing belt 20 through the insulation layer 32. Although the resistive heat generators 31 and the insulation layer 32 are disposed on the side of the base 30 facing the fixing belt 20 (that is, the fixing nip region N) according to the present embodiment, the resistive heat generators 31 and the insulation layer 32 may be disposed on the opposite side of the base 30, that is, the side facing the heater holder 23. In this case, since the heat of the resistive heat generator 31 is transmitted to the fixing belt 20 through the base 30, it is preferable that the base 30 to be made of a material with high thermal conductivity such as aluminum nitride. Making the base 30 with the material having high thermal conductivity enables to sufficiently heat the fixing belt 20 even if the resistive heat generators 31 are disposed on the side of the base 30 opposite to the side facing the fixing belt 20.

The heater holder 23 and the stay 24 are disposed on the inner circumferential face (inside the loop) of the fixing belt 20. The stay 24 is made of a channeled metallic structure or member, and both side plates of the fixing device 9 support both ends, in the longitudinal direction, of the stay 24. Since the stay 24 supports the heater holder 23 and the heater 22, the heater 22 reliably receives a pressing force of the pressure roller 21 pressed against the fixing belt 20. As a result, the fixing nip region N is stably formed between the fixing belt 20 and the pressure roller 21. In the present embodiment, the thermal conductivity of the heater holder 23 is set smaller than the thermal conductivity of the base 30.

Since the heater holder 23 is heated to a high temperature by heat from the heater 22, the heater holder 23 is preferably made of a heat resistant material. The heater holder 23 made of heat-resistant resin having low thermal conduction, such as a liquid crystal polymer (LCP) or PEEK, reduces heat transfer from the heater 22 to the heater holder 23. As a result, the heater 22 can efficiently heat the fixing belt 20. The heater holder 23 has a recess or recessed portion 23b to hold the heater 22.

As illustrated in FIG. 2, the heater holder 23 includes guide ribs (or simply a guide or guides) 26 to guide the fixing belt 20. The heater holder 23 and the guide ribs 26 may be integrated and formed as a single unit. The guide ribs 26 are disposed both upstream and downstream from the heater holder 23 in the sheet conveyance direction, and a plurality of the guide ribs 26 being arranged in the longitudinal direction.

Each of the guide ribs 26 has a substantially fan shape. Each of the guide ribs 26 has a guide face 260 that is an arc-shaped or convex curved face extending in a belt circumferential direction along the inner circumferential face of the fixing belt 20.

The heater holder 23 has openings 23al extending through the heater holder 23 in the thickness direction. The thermistor 25 is disposed in the openings 23al (details will be described below). The fixing device 9 is provided with end thermistors 25A and center thermistor 25B. The end thermistors 25A and the center thermistor 25B are collectively referred to as the thermistors 25.

The first high-thermal conduction member 28 is made of a material having a thermal conductivity higher than a thermal conductivity of the base 30. In the present embodiment, the first high-thermal conduction member 28 is a plate made of aluminum having a thickness of 0.3 mm. Alternatively, the first high-thermal conduction member 28 may be made of copper, silver, graphene, or graphite, for example. The first high-thermal conduction member 28 having a plate shape can enhance the accuracy of positioning of the heater 22 with respect to the heater holder 23 and the first high-thermal conduction member 28. The first high-thermal conduction member 28 enhances the heat transfer efficiency in the longitudinal direction, which reduces the temperature unevenness of the heater 22 and the fixing belt in the longitudinal direction. High formability and high accuracy are preferably obtained when metal was used for the first high-thermal conduction member 28.

A description is now given of a method of calculating the thermal conductivity. In order to calculate the thermal conductivity, the thermal diffusivity of a target object is first measured. The thermal conductivity is calculated using the thermal diffusivity.

The thermal diffusivity was measured using a thermal diffusivity/conductivity measuring device (trade name: AI-PHASE MOBILE 1U, manufactured by Ai-Phase co., ltd.).

In order to convert the thermal diffusivity into thermal conductivity, the values of density and specific heat capacity are to be obtained. The density was measured by a dry automatic densitometer (trade name: ACCUPYC 1330 manufactured by Shimadzu Corporation). The specific heat capacity is measured by a differential scanning calorimeter (trade name: DSC-60 manufactured by Shimadzu Corporation), and sapphire is used as a reference material in which the specific heat capacity is known. In the present embodiment, the specific heat capacity was measured five times, and an average value was calculated and used to obtain the thermal conductivity. A temperature condition was 50° C.

The thermal conductivity λ is obtained by the following expression (1).

$$λ = ρ \times C \times α \qquad ( 1 )$$

where “ρ” is the density, “C” is the specific heat capacity, and “α” is the thermal diffusivity obtained by the thermal diffusivity measurement described above.

When the fixing device 9 according to the present embodiment starts printing, the pressure roller 21 is driven to rotate and the fixing belt 20 starts to be rotated along the rotation of the pressure roller 21. The guide face 260 of each of the guide ribs 26 contacts and guides the inner circumferential face of the fixing belt 20 to stably and smoothly rotates the fixing belt 20. As power is supplied to the resistive heat generators 31 of the heater 22, the heater 22 heats the fixing belt 20. When the temperature of the fixing belt 20 reaches a fixing temperature that is a predetermined desired temperature, as illustrated in FIG. 2, the sheet P bearing an unfixed toner image is conveyed, in arrow A3 direction, to the fixing nip region N between the fixing belt 20 and the pressure roller 21, and the unfixed toner image is heated and pressed to be fixed to the sheet P.

A detailed description is now given of the heater disposed in the above-described fixing device, with reference to FIG. 3. FIG. 3 is a plan view of a heater according to the present embodiment.

As illustrated in FIG. 3, the heater 22 includes the base 30 having the planar shape. A plurality of resistive heat generators 31 (four resistive heat generators 31 in the present embodiment), power supply lines 33A and 33B that are conductors, a first electrode 34A, and a second electrode 34B are disposed on the front surface of the base 30. However, the number of resistive heat generators 31 is not limited to four in the present embodiment. The power supply lines 33A and 33B are also referred to as power supply lines 33, and the first electrode 34A and the second electrode 34B are also referred to as electrodes 34.

A left-right direction X in FIG. 3 is the longitudinal direction of the heater 22 described above and is also an arrangement direction of the plurality of resistive heat generators 31. This direction is also referred to as the arrangement direction. In addition, a vertical direction Y in FIG. 3 is a direction that intersects the arrangement direction. In particular, in the present embodiment, the vertical direction Y in FIG. 3 is the direction perpendicular to the arrangement direction of the plurality of resistive heat generators 31 and is different from a thickness direction of the base 30. This direction is also referred to as the intersect arrangement direction. The vertical direction Y is a direction along to the surface of the base 30 with the resistive heat generators 31, is a lateral direction of the heater 22, or is the sheet conveyance direction.

The plurality of resistive heat generators 31 include a plurality of heat generation portions 35 separated in the arrangement direction. The resistive heat generators 31 are electrically coupled in parallel to a pair of electrodes 34A and 34B via the power supply lines 33A and 33B. The pair of electrodes 34A and 34B is disposed on an end in the arrangement direction of the base 30, that is, the left end of the base 30 in FIG. 3. The power supply lines 33A and 33B are made of conductors having an electrical resistance value smaller than an electrical resistance value of the resistive heat generator 31. A gap area between adjacent resistive heat generators 31 disposed adjacent to each other is preferably 0.2 mm or more, more preferably 0.4 mm or more from the viewpoint of maintaining the insulation between the adjacent resistive heat generators 31. If the gap area between the adjacent resistive heat generators 31 is too large, the gap area is likely to cause a decrease in temperature in the gap area. Accordingly, from the viewpoint of reducing the temperature unevenness in the conveyance orthogonal direction, the gap area is preferably equal to or shorter than 5 mm, and more preferably equal to or shorter than 1 mm.

The resistive heat generator 31 is made of a material having a positive temperature coefficient (PTC) of resistance that is a characteristic that the resistance value increases to decrease the heater output as the temperature increases.

By the combination of the resistive heat generators 31 having the PTC characteristic and the heat generation portions 35 separated into the plurality of resistive heat generators 31 in the arrangement direction, this configuration prevents overheating of the fixing belt 20 when small-size sheets pass through the fixing device 9. When the small-sized sheets each having a width smaller than the entire width of the heat generation portion 35 pass through the fixing device 9, the temperature of a region of the resistive heat generator 31 corresponding to a region of the fixing belt 20 outside the small-size sheet increases because the small-size sheet does not absorb heat of the fixing belt 20 in the region outside the small-size sheet that is the region outside the width of the small-size sheet. Since a constant voltage is applied to the resistive heat generators 31, the temperature increase in the regions outside the width of the small-sized sheets causes the increase in resistance values of the resistive heat generators 31. The increase in temperature relatively reduces outputs (that is, heat generation amounts) of the heater in the regions, thus preventing an increase in temperature at an end of the fixing belt outside the small sheets. Electrically coupling the plurality of resistive heat generators 31 in parallel can prevent a rise of temperature in non-sheet passing regions while maintaining the printing speed. Heat generators included in the heat generation portion 35 may not be the resistive heat generators each having the PTC characteristic. The resistive heat generators in the heater 22 may be arranged in a plurality of rows arranged on the heater 22 in the intersect arrangement direction.

The resistive heat generator 31 is produced by, for example, mixing silver-palladium (AgPd) or glass powder, into a paste. The paste is coated on the base 30 by, for example, screen printing. Then, the base 30 is fired or otherwise heated to form the resistive heat generator 31. The resistive heat generators 31 each have a resistance value of 80Ω at room temperature, in the present embodiment. The material of the resistive heat generators 31 may contain a resistance material, such as silver alloy (AgPt) or ruthenium oxide (RuO2), other than the above material. Silver (Ag) or silver palladium (AgPd) may be used as a material of the power supply lines 33A and 33B and the electrodes 34A and 34B. Screen-printing such a material forms the power supply lines 33A and 33B and the electrodes 34A and 34B. The power supply lines 33A and 33B are made of conductors having the electrical resistance value smaller than the electrical resistance value of the resistive heat generators 31.

The material of the base 30 is preferably a nonmetallic material having excellent thermal resistance and insulating properties, such as glass, mica, or ceramic such as alumina or aluminum nitride. The base 30 according to the present embodiment includes an alumina base having a width of 8 mm in the intersect arrangement direction, a length of 270 mm in the arrangement direction, and a thickness of 1.0 mm. Alternatively, the base 30 may be made by layering the insulation material on conductive material such as metal. Low-cost aluminum or stainless steel is preferable as the metal material of the base 30. The base 30 made of a stainless-steel plate is resistant to cracking due to thermal stress. To enhance the thermal uniformity of the heater 22 and image quality, the base 30 may be made of a material having high thermal conductivity, such as copper, graphite, or graphene.

The insulation layer 32 may be, for example, a thermal resistance glass having a thickness of 75 μm. The insulation layer 32 covers the resistive heat generators 31 and the power supply lines 33A and 33B to insulate and protect the resistive heat generators 31 and the power supply lines 33A and 33B and maintain sliding performance with the fixing belt 20.

The heat area D is an area in which the resistive heat generators 31 are arranged in the longitudinal direction of the heater 22. The heat area D includes the gap area between the adjacent resistive heat generators 31. In other words, the area D is between a dead end in one direction of the longitudinal direction of the resistive heat generators 31 disposed at end of the one direction of the heat generation portions 35 to other dead end in other direction of the longitudinal direction, opposite to the one direction, of the resistive heat generators 31 disposed at end of the other direction of the heat generation portions 35.

The heat area D is a main heat generating area of the heater 22, but the outside of the heat area D also barely generates heat.

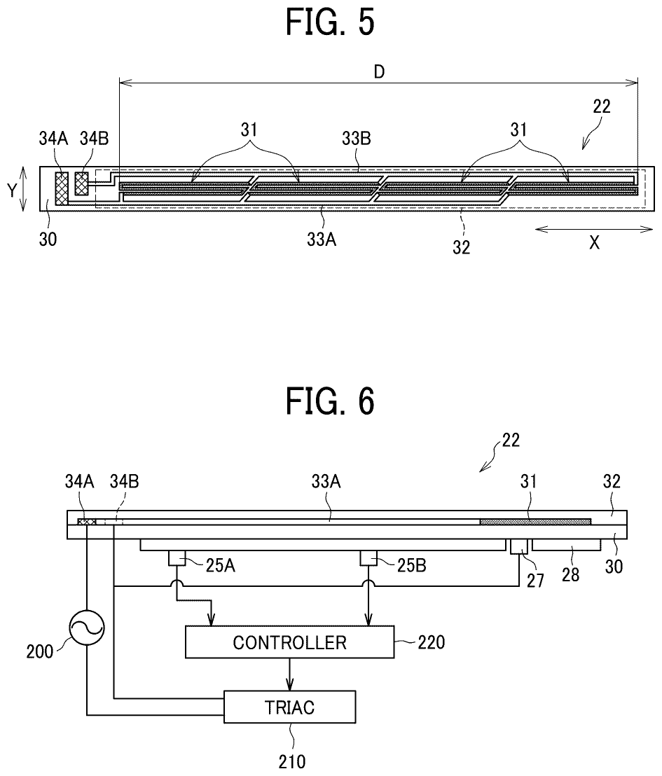

In the present embodiment, the first electrode 34A and the second electrode 34B are disposed on the same end of the heater 22 in the longitudinal direction. However, the first electrode 34A and the second electrode 34B may be disposed on different ends of the heater 22 in the longitudinal direction. The shape of the resistive heat generator 31 is not limited to the shape of the resistive heat generator 31 in the present embodiment. For example, as illustrated in FIG. 4, the shape of the resistive heat generator 31 may be a rectangular shape or, as illustrated in FIG. 5, the resistive heat generator 31 may have a linear portion folding back to form a substantially parallelogram shape. In addition, as illustrated in FIG. 4, portions each extending from the resistive heat generator 31 to the power supply line 33 (the portion extending in the intersect arrangement direction) may be a part of the resistive heat generator 31 or may be made of the same material as the power supply line 33.

FIG. 6 is a schematic diagram illustrating a circuit to supply power to the heater according to the present embodiment.

As illustrated in FIG. 6, the alternating current power supply 200 is electrically coupled to the electrodes 34A and 34B of the heater 22 to configure a power supply circuit according to the present embodiment to supply power to the resistive heat generators 31. The power supply circuit includes a triac 210 that controls an amount of power supplied. A controller 220 controls the amount of power supplied to the resistive heat generators 31 via the triac 210 based on the temperatures detected by the thermistors 25 including the end thermistor 25A and the center thermistor 25B. The controller 220 includes a microcomputer including, for example, a central processing unit (CPU), a read only memory (ROM), a random access memory (RAM), and an input and output (I/O) interface. The controller 220 may be disposed in the fixing device or in the housing of the image forming apparatus.

In the present embodiment, the end thermistor 25A serving as a first temperature sensor is disposed at one end of the heater 22 in the longitudinal direction and the center thermistor 25B serving as a second temperature sensor is disposed in the center area of the heater 22 in the longitudinal direction, within the minimum conveyance span for the smallest sheet. A thermostat 27 serving as a power cut-off device is disposed at the other end of the heater 22 in the longitudinal direction. The thermostat 27 cuts off power supply to the resistive heat generators 31 when the temperature of the resistive heat generator 31 becomes a predetermined temperature or higher.

For example, when the sheet P charged in the secondary transfer process passes through the fixing nip N2, the surface layers of the fixing belt 20 and the pressure roller 21 are charged. In addition, the surfaces of the fixing belt 20 and the pressure roller 21 are frictionally charged by the rotation of both the fixing belt 20 and the pressure roller 21. When the sheet P passes through the fixing nip N2 in a state where the surface layers of the fixing belt 20 and the pressure roller 21 are charged, the toner image on the sheet P may be electrostatic offset, which causes an abnormal image. Also when the sheet P passes through the fixing nip N2 in a state where the surface layers of the fixing belt 20 and the pressure roller 21 are charged, the sheet P might be stuck to the fixing belt 20 or the pressure roller 21 and causes paper jam (hereinafter, sheet caught problem). To avoid the above described problem, a charge eliminating brush is provided in the present embodiment.

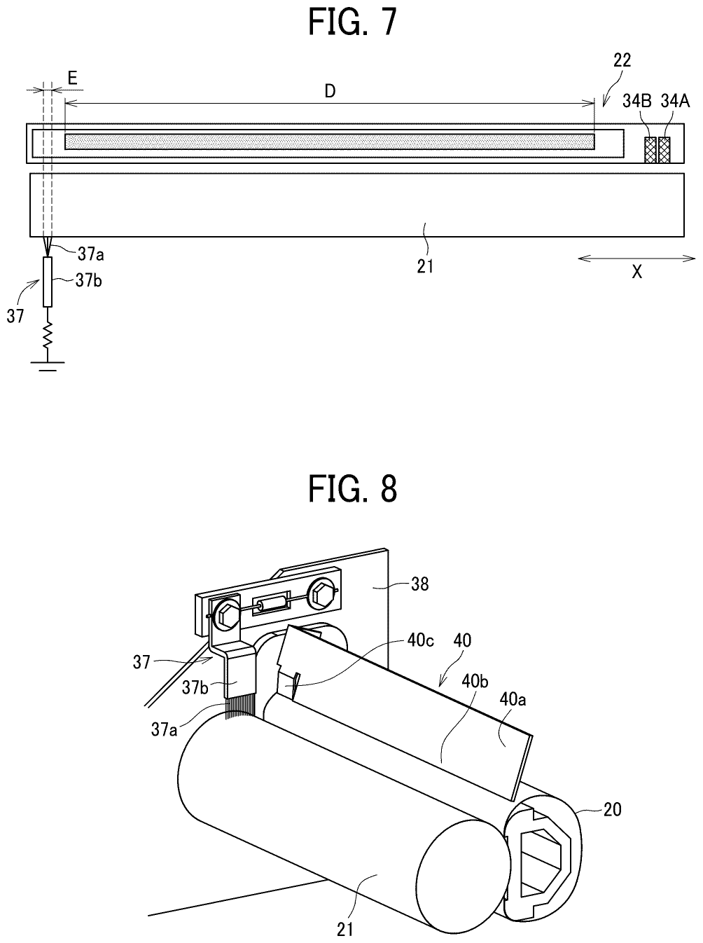

A detailed description of the charge eliminating brush is now given, with reference to FIG. 7 and FIG. 8. FIG. 7 describes the positional relationship, in longitudinal direction, between the charge eliminating brush and heater. FIG. 8 is a perspective view describing periphery of the charge eliminating brush. With respect to FIG. 7, only the charge eliminating brush, the pressing roller, and the heater are described, and the other components of the heater are simply shown in the drawing.

As shown in FIG. 7, the fixing device 9 according to the present embodiment includes the charge eliminating brush 37 as a discharger. The charge eliminating brush 37 includes a brush portion 37a as a contact member and a holding portion 37b. The charge eliminating brush 37 is grounded through a resistor. The charges on the surface layer of the pressure roller 21 are removed by contacting the charge eliminating brush 37 to the surface layer of the pressure roller 21. Such a configuration can restrict charging of the surface layers of the fixing belt 20 and the pressure roller 21 so as to prevent such problems as the electrostatic offset or the sheet P being caught to the fixing belt 20 or the pressure roller 21. Hereinafter, the range where the brush portion 37a contacts the pressing roller 21 in the longitudinal direction is referred to as a contact area E. As shown in FIG. 8, the charge eliminating brush 37 is attached to the side plate 38 of the fixing device 9.

Incidentally, calcium carbonate contained in the paper, the wax component contained in the toner, the lubricant such as grease for reducing the sliding resistance of the fixing belt, and the like are adhered to the surface of the pressure roller 21, so that they may also be adhered to the brush portion 37a which contacts the pressure roller 21. Thus, the discharging performance of the charge eliminating brush 37 may be lowered down. On the other hand, since the brush portion 37a slides the surface of the pressing roller 21, a stain of the brush portion 37a is scraped and removed, so the discharging performance may be maintained. Therefore, in order to suppress the deterioration of the discharging performance of the brush portion 37a, it is desirable to set (the speed at which the stain adheres)<(the speed at which the stain is removed). However, when the charge eliminating brush 37 is exposed to a high temperature, calcium carbonate, wax, or the like is fixed so as to be coated on the surface of the brush portion 37a by the heat, which will make it difficult to be removed by sliding with the pressure roller 21. Therefore, it becomes (the speed at which the stain adheres)>(the speed at which the stain is removed), so that the discharging performance of the charge eliminating brush 37 deteriorates.

Therefore, in the present embodiment, the brush portion 37a, which is a contact portion of the charge eliminating brush 37, is provided on the outer side than the main heat generating region D of the heater 22 in the longitudinal direction, as shown in FIG. 7. That is, the contact area E, where the brush portion 37a contacts to the pressure roller 21, is provided on the outer side than the main heat generation area D in the longitudinal direction. Thus, the brush portion 37a could be arranged on a portion avoiding the portion where the heater mainly generates heat. Therefore, it results in suppressing the brush portion 37a being exposed to high temperature, which makes it possible to increase the removal speed. Therefore, it is possible to suppress a decrease of the discharging performance of the charge eliminating brush 37 with respect to the pressure roller 21. Thus, it is possible to prevent defects such as the electrostatic offset and the sheet caught problem due to electrostatic charge of the surface layer of the pressure roller 21.

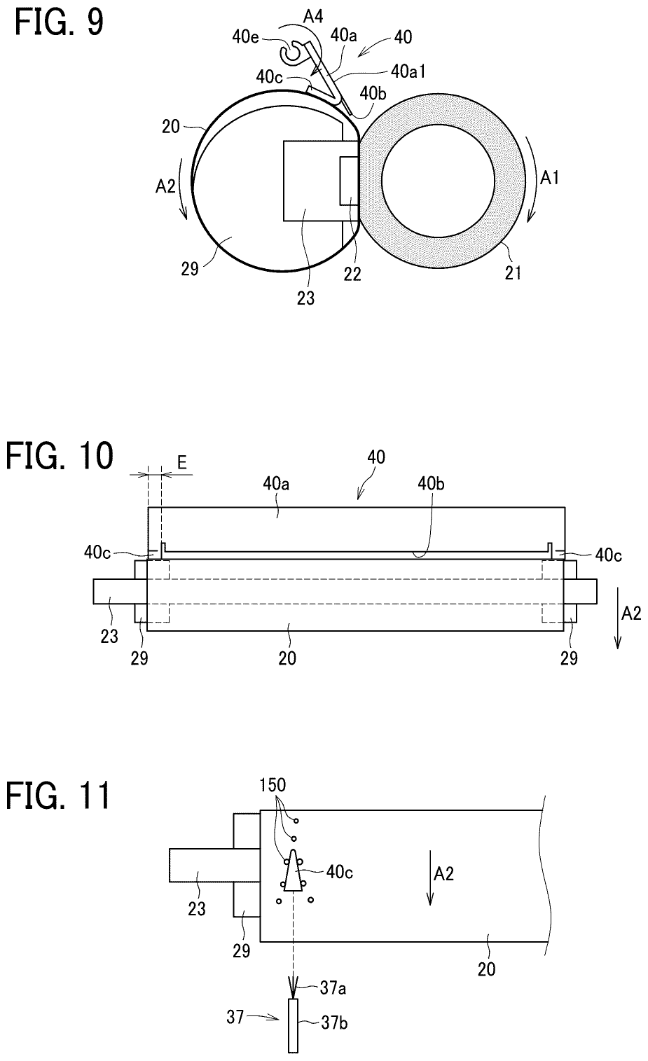

Next, a detailed configuration of the separating plate disposed in the fixing device of the present embodiment is described with reference to FIG. 9 and FIG. 10. FIG. 9 is a cross-sectional side view of a fixing device. FIG. 10 is a front diagram showing a separating plate, a fixing belt and the flange.

As illustrated in FIG. 9, the separating plate 40 is disposed on the downstream side of the fixing nip N, and separates a paper sheet from the fixing belt 20. The separating plate 40 as a separating member includes a body part 40a, a separation portion 40b, and contact parts 40c. The separation portion 40b is a portion that contacts the paper P, that has passed through the fixing nip N, to separate the sheet P from the fixing belt 20, and in particular, as to this present embodiment, it is one end portion including one end of the main body part or portion 40a close to the fixing belt 20. The contact part (also referred to as a contact portion or contact parts) 40c is a part that abuts on the outer peripheral surface of the fixing belt 20 and appropriately maintains a gap between the separating portion 40b and the fixing belt 20.

The separating plate 40 has a support part 40e at one end portion thereof in the longitudinal direction. A support shaft disposed in the housing of the fixing device is fitted into a shaft hole formed in the support part 40e. As a result, the separating plate 40 is supported rotatably with respect to the housing of the fixing device.

The separating plate 40 is biased in the direction of an arrow Ain FIG. 9 by a spring. Because of this, the contact parts 40c comes into contact with the outer circumferential surface of the fixing belt 20.

As illustrated in FIG. 10, the separating plate 40 extends in a longitudinal direction X. The contact parts 40c are disposed on both ends of the separating plate 40 in the longitudinal direction, and come into contact with the fixing belt 20 outside the sheet non-passing regions on both ends in the longitudinal direction. The separation portion 40b is disposed on the center side in the longitudinal direction between the contact parts 40c on both ends.

The separating plate 40 of the present embodiment is formed by bending a plate material. Specifically, to form the separating plate 40, the contact parts 40c and the support part 40e are bent in a different direction with respect to the body part 40a.

Flanges 29 as holding members that hold the fixing belt 20 are fitted and inserted into both ends of the fixing belt 20 in the longitudinal direction. The flanges 29 slide with the rotating fixing belt 20, and guides the rotation of the fixing belt 20.

The contact parts 40c on one side is provided so as to overlap a part or all of the aforementioned contact area E in the longitudinal direction. The separating plate 40 having the contact parts 40c is a contact member in the present embodiment. In this way, in the present embodiment, the separation plate 40 (contact member) comes into contact with the fixing belt 20 in a region where the brush portion 37a comes into contact with the pressing roller 21 (see FIG. 7), in the longitudinal direction, to be discharged. As a result, the lubricant and other deposits are scraped off by the contact parts 40c on the surface of the fixing belt 20 where the contact parts 40c contacts in the longitudinal direction. Alternatively, the contact portion 40c allows to put aside the deposit to one side and/or to the other side in the longitudinal direction. Accordingly, the amount of deposit adhering to the brush portion 37a from the surface of the fixing belt 20 via the surface of the pressure roller 21 can be suppressed. Therefore, it is possible to suppress deterioration in performance of the charge eliminating brush 37.

As described above, in the present embodiment, the contact area E is provided on the outside of the main heat generating region D to facilitate removal of deposit on the brush portion 37a (contact portion) as illustrated in FIG. 7, and as illustrated in FIG. 10, By providing the separating plate 40 (contact member) that contacts the fixing belt 20 in a part or all of the scope of the contact area E, the deposit adhering to the brush portion 37a (contact portion) may be suppressed. These make it possible to suppress the performance deterioration of the charge eliminating brush 37 (discharging member).

The above-described contact area E may be provided on outside of the maximum sheet passage area of the fixing device 9 (the area with a sheet having the maximum width could pass through the fixing device 9) in the longitudinal direction. Accordingly, it may prevent calcium carbonate and the like contained in the paper from adhering to the brush portion 37a via the surface layer of the fixing belt 20 and the pressure roller 21. Thus, it may further suppress deterioration in performance of the charge eliminating brush 37.

In addition, in a case when a sheet having a width smaller than a maximum sheet width passes through the fixing device 9 continuously, the sheet feeding interval to the fixing device may be made larger than that of a sheet having the maximum sheet width. In other words, it could reduce the productivity of the printing by increasing the printing interval of the image forming apparatus. When the paper having the width smaller than the maximum sheet width passes through the fixing device 9, the non-threading region may be formed in the main heat generating region D, and the temperature easily rises in the non-threading region, which leads to the temperature rise of the brush portion 37a. On the other hand, by increasing the sheet feeding interval, it is possible to suppress the temperature rise of the non-threading region and the brush portion 37a. Thus, it suppresses the sticking of the deposit on the brush portion 37a, which leads to further suppression of the performance reduction of the charge eliminating brush 37.

Further, when a sheet having a width smaller than a maximum sheet width (small width) passes through the fixing device 9 continuously, the subsequent sheet passing interval may be enlarged to more than the previous sheet which will lead to reduce the productivity. In the case when the sheets having the small width is continuously fed, the temperature rise of the non-threading region in the fixing device 9 increases as the sheet passes. Therefore, by increasing the paper passing interval as the sheet passes, the productivity may be lowered in accordance with the temperature increase in the fixing device 9. As a result, it enables effective suppression to the temperature rise of the non-sheet passing region while suppressing the reduction in productivity of the image forming apparatus and the fixing device 9. Therefore, it is possible to achieve both suppression of deterioration in performance of the charge eliminating brush 37 and securing of productivity of the image forming apparatus and the fixing device 9. When the three or more sheets having the small width continuously passes, the sheet passing interval may be increased for each sheet step by step, or the sheet passing interval may be increased after a certain number of sheets passed, but those are the example and how to increase the interval may be appropriately selected.

In the case where the image forming operation is continuously performed on the coated sheet, that is, in the case where the coated sheet is continuously passed through the fixing device 9, reducing the productivity by widening the sheet passing interval as compared with the case where the other recording medium like the plain paper is also possible. The coated sheet is likely to retain static electricity and requires greater static elimination capability. Therefore, in the case when the coated sheet is passed through, the charge eliminating brush 37 can sufficiently neutralize the pressure roller 21 by lowering the productivity in the image forming device or the fixing device 9. However, the other recording medium referred to in above does not always mean all the recording media which may be used in the fixing device 9 other than the coated sheet, it may be some of the recording medium other than the coated sheet.

Next, a modification of the contact portion 40c shown in FIG. 10 will be described.

FIG. 11 shows a portion of the contact portion 40c that abuts on the surface of the fixing belt 20. In FIG. 11, the downstream side of the contact portion 40c in the rotation direction A2 of the fixing belt 20 has larger contact width than the upstream side of the contact portion 40c. As a result, the deposit 150 on the surface of the fixing belt 20 can flow along the surface of the contact portion 40c to one side and the other side in the longitudinal direction as shown in FIG. 11. As a result, adhesion of the deposit 150 to the brush portion 37a can be suppressed.

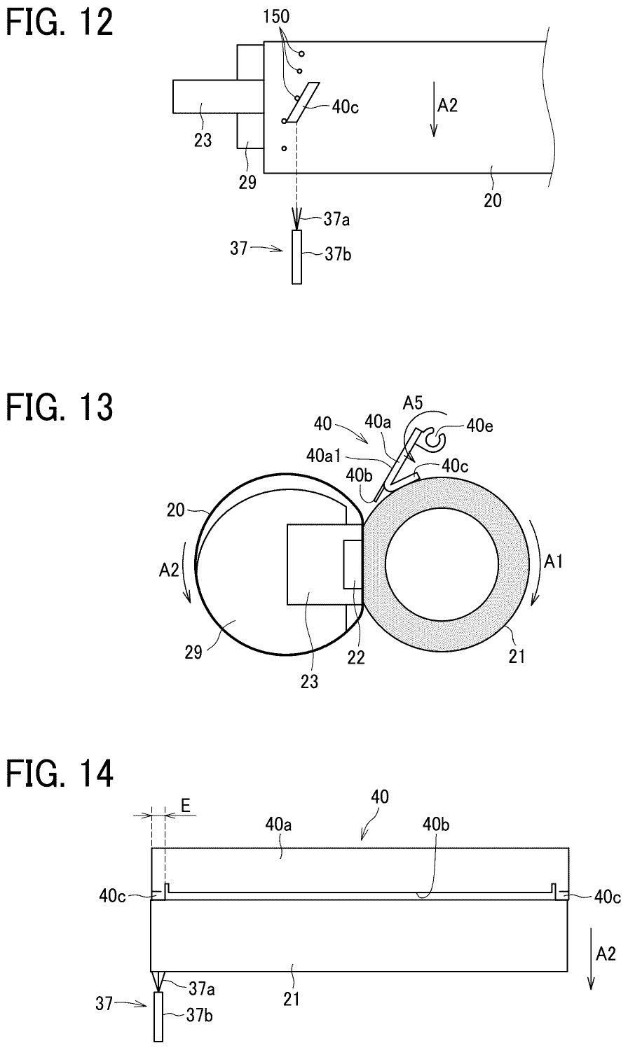

The contact portion 40c of the embodiment shown in FIG. 12 is inclined toward the downstream side from the upstream side in the rotation direction A2 of the fixing belt 20 to the outside in the longitudinal direction (the left side in FIG. 12). As a result, the deposit 150 on the surface of the fixing belt 20 can flow to the outside in the longitudinal direction along the surface of the contact portion 40c as shown in FIG. 12. As a result, adhesion of the deposit 150 to the brush portion 37a can be suppressed. However, the contact portion 40c may be inclined from the upstream side to the downstream side in the rotation direction A2 of the fixing belt 20 toward the inside in the longitudinal direction (the right side in FIG. 12).

In the fixing device illustrated in FIG. 2, the separating plate 40 is disposed on the fixing belt 20 side and the contact portion 40c is brought into contact with the fixing belt 20, but it may be disposed on the pressing roller 21 side. For example, in the fixing device 9 of the embodiment shown in FIG. 13, the separating plate 40 serving as the separation member is biased in the direction of the arrow A5 so that the contact portion 40c comes into contact with the surface of the pressing roller 21, and a predetermined gap is provided between the separation portion 40b and the pressing roller 21. As shown in FIG. 14, the contact portion 40c contacts the pressing roller 21 at a position overlapping the contact area E in the longitudinal direction. Other configurations are basically the same as those of the embodiment of FIG. 2. That is, even in this embodiment, the brush portion 37a is provided on the outside of the main heating region D of the heater 22 (see FIG. 7). As a result, it enables to suppress deterioration in performance of the charge eliminating brush 37. However, in the embodiment of FIG. 13, another separation member may be provided on the fixing belt 20 side.

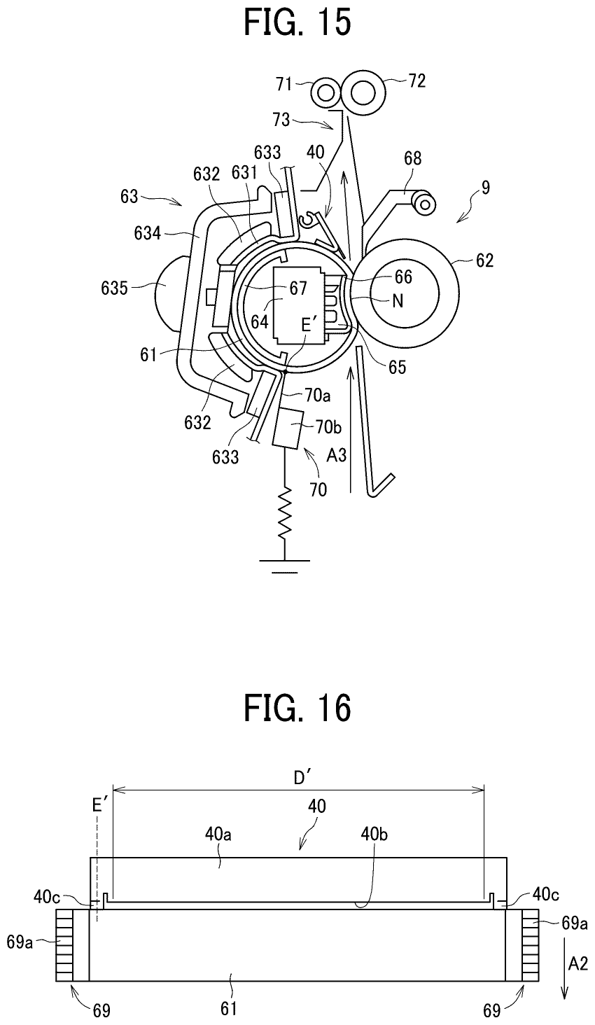

Next, a fixing device having a configuration different from that of FIG. 2 will be described with reference to FIG. 15. In the following description, differences from the embodiment of FIG. 2 will be described.

FIG. 15 is a fixing device 9 having an induction heater 63 as a heating body. The fixing device 9 includes a fixing belt 61, a pressing roller 62, an induction heater 63, a stay 64, a nip forming member 65, a sliding sheet 66, a heat storage plate 67, a separation plate 40 and a separation claw 68 as a separation member, and a charge eliminating needle 70 as a charge eliminating member. On the downstream side of the fixing device 9 in the paper conveying direction, an outlet roller 71, a sheet ejecting roller 72, and a sheet ejecting filler 73 are provided. The sheet conveyed to the nip portion of the exit roller 71 and the paper ejection roller 72 is ejected to the outside of the image forming apparatus.

The induction heater 63 is fixed to the main body of the image forming apparatus. The coil 632 is held on the outer surface of the coil holder 631 formed along the outer peripheral surface of the fixing belt 61. A convex portion for positioning with the fixing belt 61 is provided at both longitudinal ends of the coil holder 631. Power is supplied to the coil 632 to generate a magnetic field, then a current due to electromagnetic induction flows through the base layer of the fixing belt 61, and Joule heat is generated in the fixing belt 61 and/or the heat storage plate 67. The core 633, 634, 635 is formed of a ferromagnetic material, to form a magnetic path for passing the magnetic flux generated from the coil 632. Main heating area by the induction heater 63 of the present embodiment is the region where the coil 632 is provided in the longitudinal direction, that is, the longitudinally region from the position where the coil 632 on one side of the longitudinal direction is provided to the position where the coil 632 on the other side of the longitudinal direction is provided.

The nip forming member 65 forms a fixing nip N between the fixing belt 61 and the pressing roller 62. The fixing nip N is formed along the surface shape of the nip forming member 65 on the side of the fixing belt 61. In this embodiment, the nip forming member 65 is formed of a resin material. A sliding sheet 66 is provided between the fixing belt 61 and the nip forming member 65, and the sliding sheet 66 is impregnated with a lubricant. The nip forming member 65 is supported by the stay 64 from its rear side, and is positioned at a position in contact with the inner peripheral surface of the fixing belt 61 via a sliding sheet 66. The sliding sheet 66 and the lubricant are interposed between the fixing belt 61 and the nip forming member 65, thereby it may suppress the sliding resistance between the fixing belt 61 and the nip forming member 65. The heat storage plate 67 contacts the inner peripheral surface of the induction heater 63 side of the fixing belt 61. The heat storage plate 67 is formed in a semicircular arc shape along the inner peripheral surface of the fixing belt 61.

The charge eliminating needle 70 is grounded. The charge eliminating needle 70 makes the charge eliminating portion 70a contact with the surface layer of the fixing belt 61 to neutralize (discharge) the fixing belt 61. The surface layer of the fixing belt 61 has conductivity. The contact position (contact area) at which the tip end of the charge eliminating portion 70a contacts the surface layer of the fixing belt 61 is defined as the contact region E′.

As shown in FIG. 16, the fixing belt 61 is held at both ends in the longitudinal direction by the flange 69. Flange 69 has a gear portion 69a. The flange 69 is formed of a resin material. A buffer material is provided between the flange 69 and the fixing belt 61. During decompression of the fixing belt 61, the driving force is transmitted through the gear portion 69a to rotate the fixing belt 61. When the pressure roller 62 is pressurized with respect to the fixing belt 61, the fixing belt 61 is driven to rotate by the rotation of the pressure roller 62.

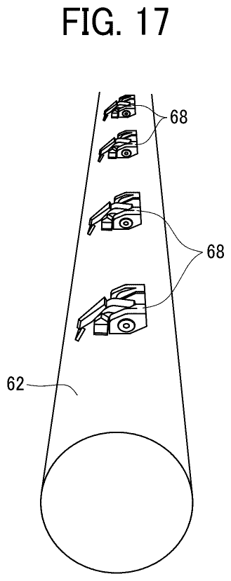

As shown in FIG. 17, at the outlet side of the fixing nip, not only is the separation plate 40 provided on the fixing belt 61 side, there is the separation claw 68 provided on the pressure roller 62 side. The separation claw 68 is provided at four positions in the longitudinal direction and contacts the surface of the pressing roller 62. The separating claw 68 allows the paper passing through the fixing nip to be separated from the pressing roller and transported to the discharge section on the downstream side. The separation plate 40 has the same configuration as that of the above-described embodiment.

As shown in FIG. 16, at a position corresponding to the longitudinal contact region E′, the contact portion 40c (contact portion) of the separation plate 40 comes into contact with the fixing belt 61 in the fixing device of this embodiment. As a result, it enables the suppression of deposits adhering to the charge eliminating portion 70a and suppression of deterioration in performance of the charge eliminating needle 70. The contact region E′ in which the charge eliminating needle 70 contacts the fixing belt 61 is provided outside the main heating region D′ of the induction heater 63 in the longitudinal direction. Accordingly, it enables to prevent the charge eliminating portion 70a from being exposed to a high temperature, and to prevent the performance of the charge eliminating needle 70 from deteriorating. Main heating region D′ of the induction heater 63 is a region where the coil 632 is provided in the longitudinal direction (see FIG. 15).

Next, after the description of the first high-thermal conduction member 28 of the fixing device 9 shown in FIG. 2, a modification of the fixing device 9 having the first high-thermal conduction member 28 and the fixing device of the other embodiments will be described.

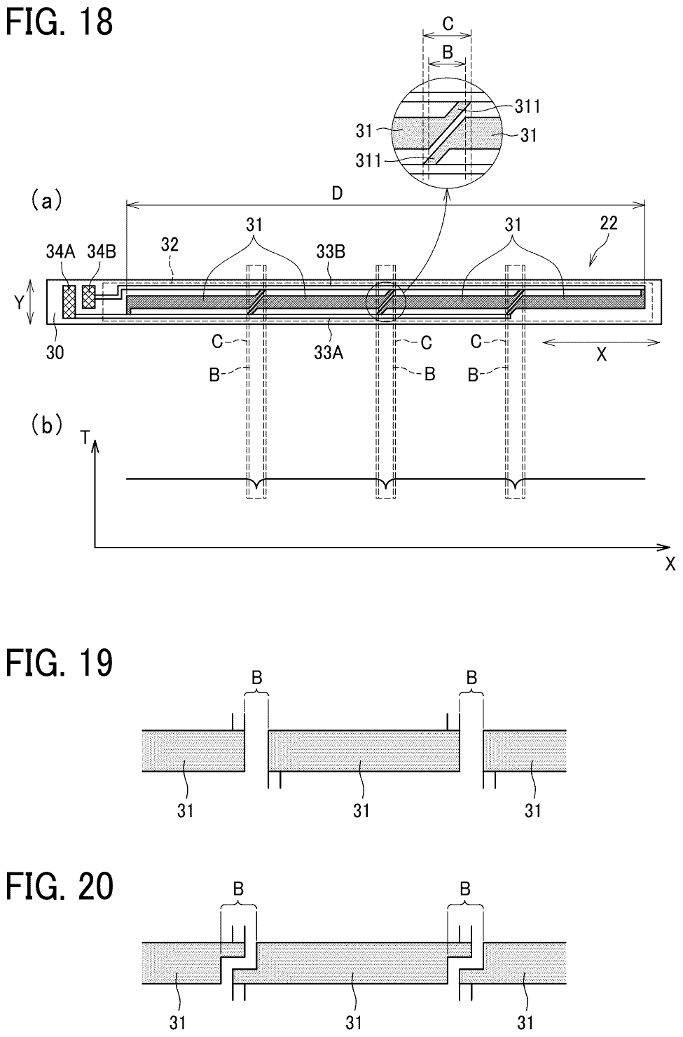

FIG. 18 is a diagram illustrating a temperature distribution of a fixing belt in the longitudinal direction of the fixing belt 20, including (a) a plan view of the heater and (b) a graph illustrating the temperature distribution of the fixing belt 20. Diagram (a) of FIG. 18 illustrates the arrangement of the resistive heat generators 31 of the heater 22. In the graph of (b) of FIG. 18, a vertical axis represents the temperature T of the fixing belt 20, and a horizontal axis represents the position of the fixing belt 20 in the longitudinal direction.

As illustrated in (a) of FIG. 18, the plurality of resistive heat generators 31 of the heater 22 are separated from each other in the longitudinal direction to form separation areas B including gap areas between the neighboring resistive heat generators 31. In other words, the heater 22 has gap areas between the plurality of resistive heat generators 31. Hereinafter, the separation area B may be called gap B.

The area occupied by the resistive heat generators 31 in the separation area B is smaller than the area occupied by the resistive heat generators 31 in another area of the heat generation portion, and the amount of heat generated in the separation area B is smaller than the amount of heat generated in another area of the heat generation portion. As a result, the temperature of the fixing belt 20 corresponding to the separation area B becomes smaller than the temperature of the fixing belt 20 corresponding to another area, which causes temperature unevenness in the longitudinal direction of the fixing belt 20 as illustrated in (b) of FIG. 18. Similarly, in an enlarged separation area C including areas corresponding the separation area B and their surroundings (may be called as area C), the temperature of the heater 22 or/and the fixing belt 20 corresponding to the separation area B becomes smaller than the temperature of another area. In addition to, as in the enlarged view of (a) of FIG. 18, the separation area B defines a hole range in the arrangement direction (longitudinal direction) including a part of the heat generation portion where the separation area B disposing. The areas corresponding to connection portions 311 of the resistive heat generators 31 in addition to the separation area B are defined as area C. The connection portion 311 is defined as a portion of the resistive heat generator 31 that extends in the short-side direction and is connected to one of the power supply lines 33A and 33B.

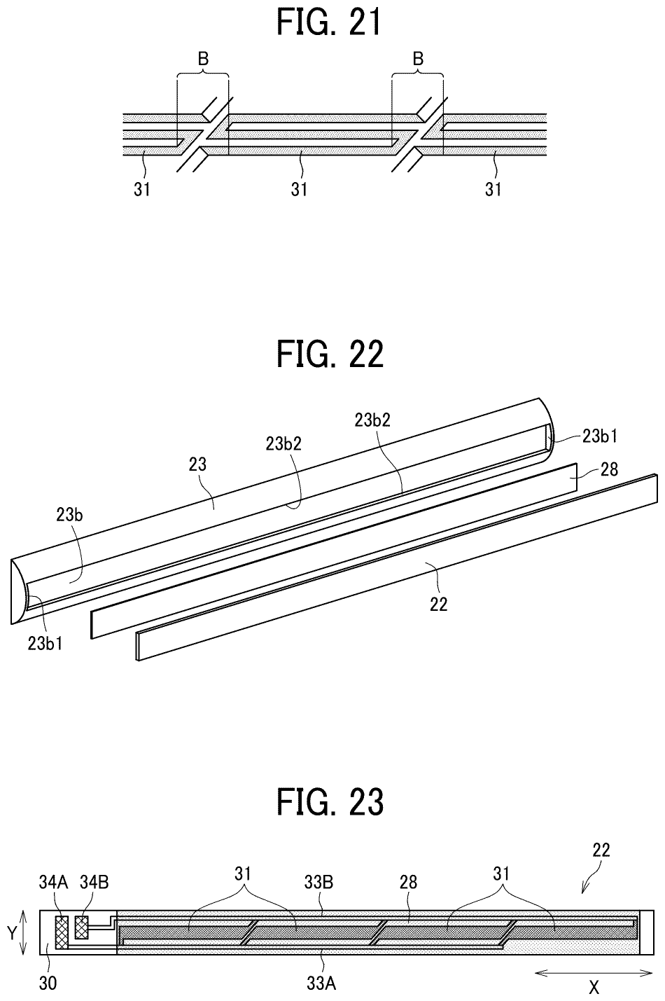

As illustrated in FIG. 19, the heater 22 including the rectangular resistive heat generators 31 illustrated in FIG. 4 also has the separation areas B having lower temperatures than another area of the heat generation portion 35. In addition, the heater 22 including the resistive heat generators 31 having forms as illustrated in FIG. 20 has the separation areas B with lower temperatures than another area of the heat generation portion 35. As illustrated in FIG. 21, the heater 22 including the resistive heat generators 31 having forms as illustrated in FIG. 5 has the separation areas B with lower temperatures than another area of the heat generation portion 35. However, overlapping the resistive heat generators 31 lying next to each other in the longitudinal direction as illustrated in FIGS. 18, 20, and 21 can reduce the above-described temperature drop that the temperature of the separation area B is smaller than the temperature of an area other than the separation area B.

The fixing device 9 in the present embodiment includes the first high thermal conduction member 28 described above in order to reduce the temperature drop corresponding to the separation area B as described above and reduce the temperature unevenness in the longitudinal direction of the fixing belt 20. Next, a detailed description is given of the first high thermal conduction member 28.

As illustrated in FIG. 2, the first high thermal conduction member 28 is disposed between the heater 22 and the stay 24 in the lateral direction of FIG. 2 and is sandwiched between the heater 22 and the heater holder 23. One side of the first high thermal conduction member 28 is brought into contact with the back surface of the base 30, and the other side of the first high thermal conduction member 28 is brought into contact with the heater holder 23.

The stay 24 has two rectangular portions 24a extending in a thickness direction of the heater 22 and each having a contact surface 24al that contacts the back side of the heater holder 23 to support the heater holder 23, the first high thermal conduction member 28, and the heater 22. In the short-side direction that is the vertical direction in FIG. 2, the contact surfaces 24al are outside the resistive heat generators 31. The above-described structure prevents heat transfer from the heater 22 to the stay 24 and enables the heater 22 to effectively heat the fixing belt 20.

As illustrated in FIG. 22, the first high thermal conduction member 28 is a plate, which has the thickness 0.3 mm, the arrangement direction (longitudinal direction) length 222 mm, and the direction perpendicular to the arrangement direction length 10 mm. In the present embodiment, the first high thermal conduction member 28 is made of a single plate but may be made of a plurality of plates or members. In FIG. 22, the guide 26 in FIG. 2 is omitted from the drawing.

The first high thermal conduction member 28 is fitted into the recessed portion 23b of the heater holder 23, and the heater 22 is mounted thereon. Thus, the first high thermal conduction member 28 is sandwiched and held between the heater holder 23 and the heater 22. In the present embodiment, the length of the first high thermal conduction member 28 in the longitudinal direction is substantially the same as the length of the heater 22 in the longitudinal direction. Both side walls 23b1 forming the recessed portion 23b in the longitudinal direction restrict movement of the heater 22 and movement of the first high thermal conduction member 28 in the longitudinal direction and work as longitudinal direction regulators. Reducing the positional deviation of the first high thermal conduction member 28 in the longitudinal direction in the fixing device 9 improves the thermal conductivity efficiency with respect to a target range in the longitudinal direction. In addition, both side walls 23b2 forming the recessed portion 23b in the direction perpendicular to the longitudinal direction (short-side direction) restricts movement of the heater 22 and movement of the first high thermal conduction member 28 in the short-side direction and work as short-side direction regulators.

The range in which the first high thermal conduction member 28 is disposed in the longitudinal direction is not limited to the above. For example, as illustrated in FIG. 23, the first high thermal conduction member 28 may be disposed so as to face a range corresponding to the heat generation portion 35 in the longitudinal direction (see a hatched portion in FIG. 23).

Due to the pressing force of the pressure roller 21, the first high thermal conduction member 28 is sandwiched between the heater 22 and the heater holder 23 and is brought into close contact with the heater 22 and the heater holder 23. Bringing the first high thermal conduction member 28 into contact with the heaters 22 improves the heat conduction efficiency in the longitudinal direction of the heaters 22. The first high thermal conduction member 28 facing the separation area B improves the heat conduction efficiency of a part of the heater 22 facing the separation area B in the longitudinal direction, transmits heat to the part of the heater 22 facing the separation area B, and raises the temperature of the part of the heater 22 facing the separation area B. As a result, the first high thermal conduction member 28 reduces the temperature unevenness in the longitudinal direction of the heaters 22. Thus, temperature unevenness in the longitudinal direction of the fixing belt 20 is reduced. Therefore, the above-described structure prevents fixing unevenness and gloss unevenness in the image fixed on the sheet. Since the heater 22 does not need to generate additional heat to secure sufficient fixing performance in the part of the heater 22 facing the separation area B, energy consumption of the fixing device 9 can be saved. The first high thermal conduction member 28 disposed over the entire area of the heat generation portion 35 in the longitudinal direction improves the heat transfer efficiency of the heater 22 over the entire area of a main heating region of the heater 22, that is, an area facing an image formation area of the sheet passing through the fixing device and reduces the temperature unevenness of the heater 22 and the temperature unevenness of the fixing belt 20 in the longitudinal direction.

In the present embodiment, the combination of the first high thermal conduction member 28 and the resistive heat generator 31 having the PTC characteristic described above efficiently prevents overheating of the non-sheet passing region (that is the region of the fixing belt outside the small sheet) of the fixing belt 20 when small sheets pass through the fixing device 9. Specifically, the PTC characteristic reduces the amount of heat generated by the resistive heat generator 31 in the non-sheet passing region, and the first high thermal conduction member effectively transfers heat from the non-sheet passing region in which the temperature rises to a sheet passing region that is a region of the fixing belt contacting the sheet. As a result, the overheating of the non-sheet passing region is effectively prevented.

The first high thermal conduction member 28 may be disposed opposite an area around the separation area B because the small heat generation amount in the separation area B decreases the temperature in the area around the separation area B. For example, the first high thermal conduction member 28 facing the enlarged separation area C (see (a) of FIG. 18) particularly improves the heat transfer efficiency of the separation area B and the area around the separation area B in the longitudinal direction and reduces the temperature unevenness of the heater 22 in the longitudinal direction. In particular, the first high thermal conduction member 28 facing the entire region of the heat generation portion 35 in the longitudinal direction reduces the temperature unevenness of the heater 22 (and the fixing belt 20) in the longitudinal direction.

Next, different embodiments of the fixing device are described.

As illustrated in FIG. 24, the fixing device 9 according to another embodiment includes a second high thermal conduction member 36 between the heater holder 23 and the first high thermal conduction member 28. The second high thermal conduction member 36 is disposed at a position different from the position of the first high thermal conduction member 28 in the lateral direction in FIG. 24 that is a direction in which the heater holder 23, the stay 24, and the first high thermal conduction member 28 are layered. Specifically, the second high thermal conduction member 36 is disposed so as to overlap the first high thermal conduction member 28. FIG. 24 illustrates a schematic cross section of the fixing device 9 including the second high thermal conduction member 36 that transmits heat in the longitudinal direction, and the position of the schematic cross section is different from the position of the thermistor illustrated in FIG. 2.

The second high thermal conduction member 36 is made of a material having thermal conductivity higher than the thermal conductivity of the base 30, for example, graphene or graphite. In the present embodiment, the second high thermal conduction member 36 is made of a graphite sheet having a thickness of 1 mm. Alternatively, the second high thermal conduction member 36 may be a plate made of aluminum, copper, silver, or the like.

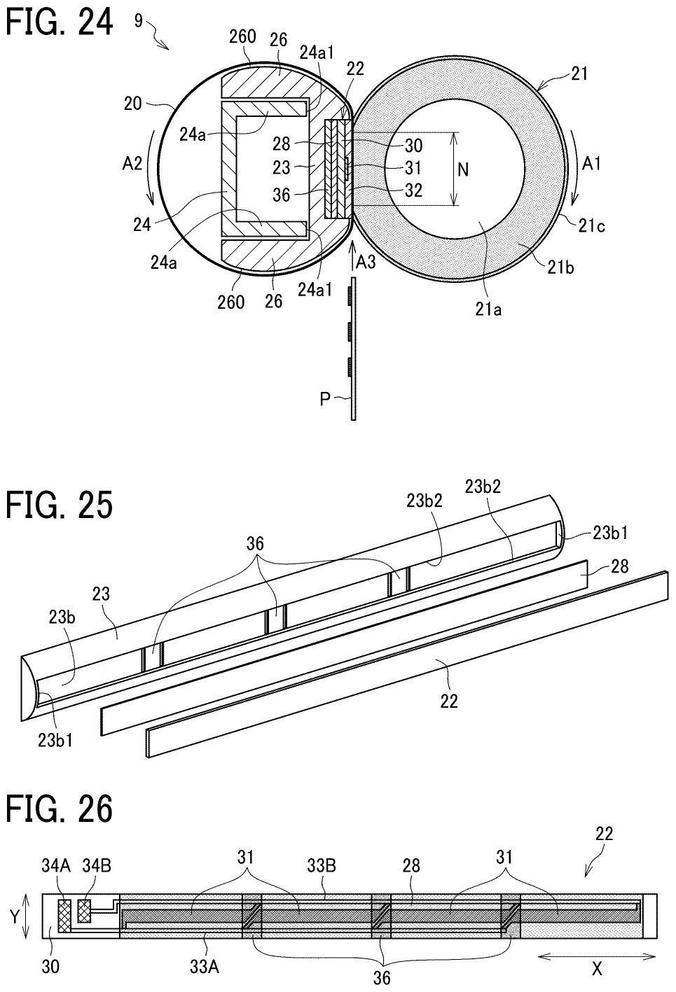

As illustrated in FIG. 25, a plurality of the second high thermal conduction members 36 are disposed on a plurality of portions of the heater holder 23 in the longitudinal direction. The recessed portion 23b of the heater holder 23 has a plurality of holes in which the second high thermal conduction members 36 are disposed. Clearances are formed between the heater holder 23 and both sides of the second high thermal conduction member 36 in the longitudinal direction. The clearance prevents heat transfer from the second high thermal conduction member 36 to the heater holder 23, and the heater 22 can efficiently heat the fixing belt 20. In FIG. 25, the guide 26 in FIG. 2 is omitted from the drawing.

As illustrated in FIG. 26, each of the second high thermal conduction members 36 (see the hatched portions) is disposed at a position corresponding to the separation area B in the longitudinal direction and faces at least a part of each of the neighboring resistive heat generators 31 in the longitudinal direction. In particular, each of the second high thermal conduction members 36 in the present embodiment faces the entire separation area B. Further, the second high thermal conduction members 36 are disposed at a position different from a position where the thermistor or the thermostat is arranged. This could reduce the temperature unevenness of the heater 22 and the fixing belt 20 in the longitudinal direction.

In one embodiment different from the embodiments described above, each of the first high thermal conduction member 28 and the second high thermal conduction member 36 is made of a graphene sheet. The first high thermal conduction member 28 and the second high thermal conduction member 36 made of the graphene sheet have high thermal conductivity in a predetermined direction along the plane of the graphene, that is, not in the thickness direction but in the longitudinal direction. Accordingly, the above-described structure can effectively reduce the temperature unevenness of the fixing belt 20 in the longitudinal direction and the temperature unevenness of the heater 22 in the longitudinal direction.

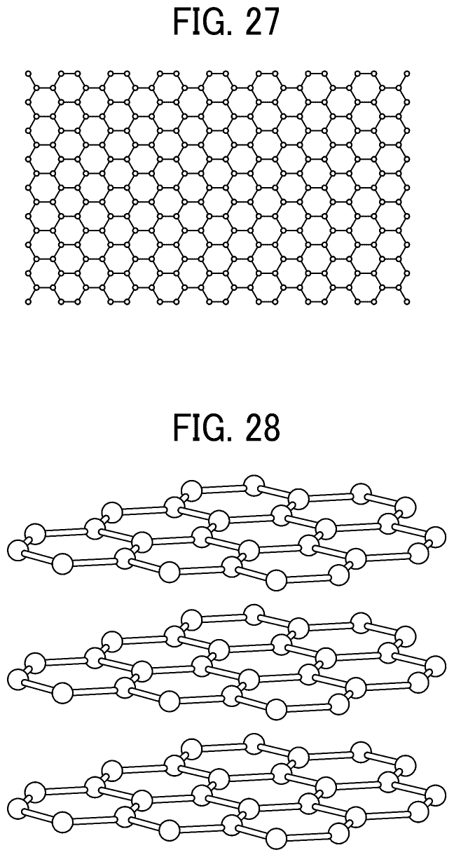

Graphene is a flaky powder. Graphene has a planar hexagonal lattice structure of carbon atoms, as illustrated in FIG. 27. The graphene sheet is usually a single layer. The single layer of carbon may contain impurities. The graphene may have a fullerene structure. The fullerene structures are generally recognized as compounds including an even number of carbon atoms, which form a cage-like fused ring polycyclic system with five and six membered rings, including, for example, C60, C70, and C80 fullerenes or other closed cage structures having three-coordinate carbon atoms.

Graphene sheets are artificially made by, for example, a chemical vapor deposition (CVD) method. The graphene sheet is commercially available. The size and thickness of the graphene sheet or the number of layers of the graphite sheet described later are measured by, for example, a transmission electron microscope (TEM).

Graphite obtained by multilayering graphene has a large thermal conduction anisotropy. As illustrated in FIG. 28, graphite has a crystal structure formed by layering a number of layers each having a condensed six membered ring layer plane of carbon atoms extending in a planar shape. Among carbon atoms in this crystal structure, adjacent carbon atoms in the layer are coupled by a covalent bond, and carbon atoms between layers are coupled by a van der Waals bond. The covalent bond has a larger bonding force than a van der Waals bond. Therefore, there is a large anisotropy between the bond between carbon atoms in a layer and the bond between carbon atoms in different layers. That is, the first high thermal conduction member 28 and the second high thermal conduction member 36 that are made of graphite each have the heat transfer efficiency in the longitudinal direction larger than the heat transfer efficiency in the thickness direction of the first high thermal conduction member 28 and the second high thermal conduction member 36 (that is, the stacking direction of these members), reducing the heat transferred to the heater holder 23. Accordingly, the above-described structure can efficiently decrease the temperature unevenness of the heater 22 in the longitudinal direction and can minimize the heat transferred to the heater holder 23. Since the first high thermal conduction member 28 and the second high thermal conduction member 36 that are made of graphite are not oxidized at about 700 degrees or lower, the first high thermal conduction member 28 and the second high thermal conduction member 36 each have an excellent heat resistance.

The physical properties and dimensions of the graphite sheet may be appropriately changed according to the function required for the first high thermal conduction member 28 or the second high thermal conduction member 36. For example, the anisotropy of the thermal conduction can be increased by using high-purity graphite or single-crystal graphite or increasing the thickness of the graphite sheet. Using a thin graphite sheet can reduce the thermal capacity of the fixing device 9 so that the fixing device 9 can perform high speed printing. A width of the first high thermal conduction member 28 or a width of the second high thermal conduction member 36 may be increased in response to a large width of the fixing nip N2 or a large width of the heater 22.

From the viewpoint of increasing mechanical strength, the number of layers of the graphite sheet is preferably 11 or more. The graphite sheet may partially include a single layer portion and a multilayer portion.

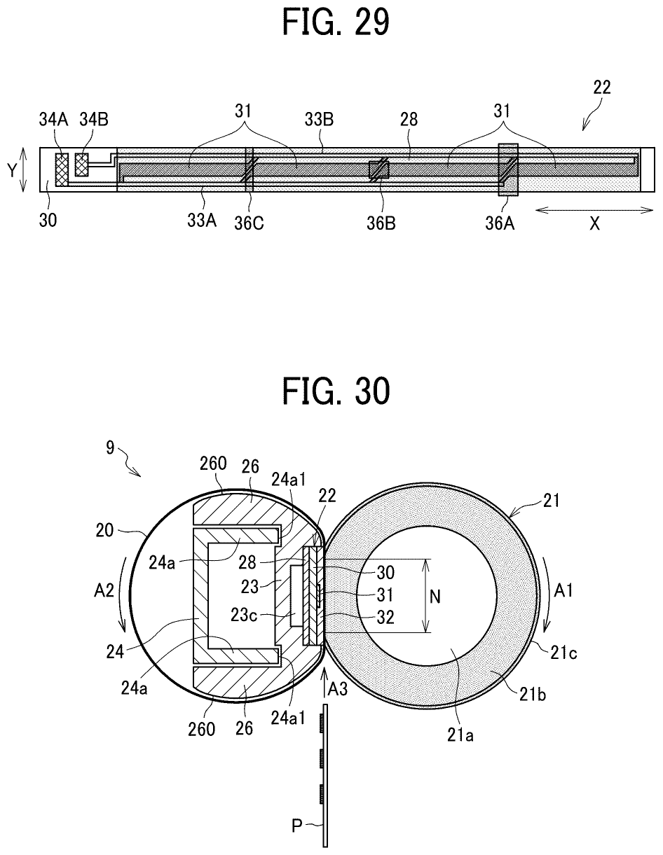

As long as the second high thermal conduction member 36 faces a part of each of neighboring resistive heat generators 31 and at least a part of the gap area between the neighboring resistive heat generators 31, the configuration of the second high thermal conduction member 36 is not limited to the configuration illustrated in FIG. 26. For example, as illustrated in FIG. 29, a second high thermal conduction member 36A is longer than the base 30 in the short-side direction, and both ends of the second high thermal conduction member 36A in the short-side direction are outside the base 30 in FIG. 29. A second high thermal conduction member 36B faces a range in which the resistive heat generator 31 is disposed in the short-side direction. A second high thermal conduction member 36C faces a part of the gap area and a part of each of neighboring resistive heat generators 31.

As illustrated in FIG. 30, the fixing device according to another embodiment has a gap between the first high thermal conduction member 28 and the heater holder 23 in the thickness direction that is the lateral direction in FIG. 30. In other words, the fixing device 9 has a gap 23c serving as a thermal insulation layer. In the longitudinal direction, the gap 23c is in a portion included in the recessed portion 23b (see FIG. 25) in the heater holder 23 to set the heater 22, the first high thermal conduction member 28, and the second high thermal conduction member 36, but the second high thermal conduction member 36 is not set in the portion of the gap 23c. In the short-side direction, the gap 23c is in a portion of the recessed portion 23b having a depth deeper than other portions to receive the first high thermal conduction member 28. The portion may be arranged at a whole or a part of a portion excluding where the second thermal conduction member 36 is disposed in the longitudinal direction and at a part of a portion in the short-side direction. The above-described structure minimizes the contact area between the heater holder 23 and the first high thermal conduction member 28. Minimizing the contact area prevents heat transfer from the first high thermal conduction member 28 to the heater holder 23 and enables the heater 22 to efficiently heat the fixing belt 20. In the cross section of the fixing device 9 in which the second high thermal conduction member 36 is set, the second high thermal conduction member 36 is in contact with the heater holder 23 as illustrated in FIG. 24 of the above-described embodiment.

In particular, the fixing device 9 according to the present embodiment has the gap 23c facing the entire area of the resistive heat generators 31 in the short-side direction that is the vertical direction in FIG. 30. The gap 23c prevents heat transfer from the first high thermal conduction member 28 to the heater holder 23, and the heater 22 can efficiently heat the fixing belt 20. The fixing device 9 may include a thermal insulation layer made of heat insulator having a lower thermal conductivity than the thermal conductivity of the heater holder 23 instead of a space like the gap 23c serving as the thermal insulation layer.

In the above description, the second high thermal conduction member 36 is a member different from the first high thermal conduction member 28, but the present embodiment is not limited to this. For example, the first high thermal conduction member 28 may have a thicker portion than the other portion so that the thicker portion faces the separation area B.

In the above the embodiments illustrated in FIG. 24 and FIG. 30, the above mentioned charge eliminating brush, contact members (separation plate), and heaters et al. could also be adapted as well. As a result, it may suppress the sticking of the deposit on the brush portion 37a, which leads to further suppression of the performance reduction of the charge eliminating brush 37.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

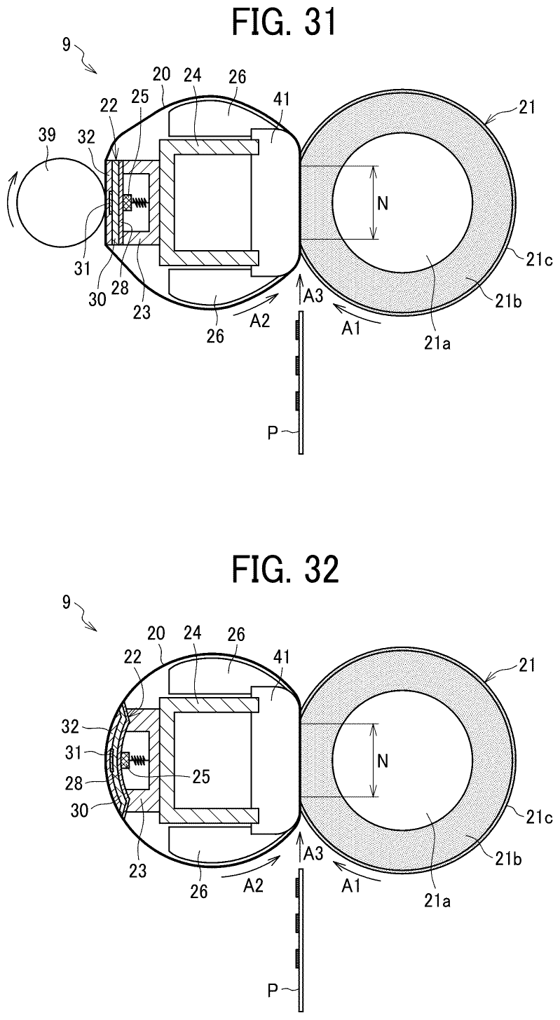

The embodiments of the present disclosure are also applicable to fixing devices as illustrated in FIGS. 31, 32, and 33, respectively, which are described below, in addition to the fixing device 9 described above.

The fixing device 9 illustrated in FIG. 31 includes a pressure roller 39 opposite the pressure roller 21 with respect to the fixing belt 20. The pressure roller 39 is a counter rotator that rotates at the position facing the fixing belt 20 serving as a rotator. The fixing belt 20 is sandwiched by the pressure roller 39 and the heater 22 and is heated by the heater 22. On the other hand, a nip formation pad 41 serving as a nip former is disposed on the inner circumference of the fixing belt 20 at the pressure roller 21 side. The nip formation pad 41 is supported by the stay 24. The nip formation pad 41 sandwiches the fixing belt 20 together with the pressure roller 21, thereby forming the fixing nip region N.

A configuration of the fixing device 9 is described below, with reference to FIG. 32. The fixing device 9 illustrated in FIG. 39 does not include the pressure roller 39 illustrated in FIG. 31. In order to attain a contact length for which the heater 22 contacts the fixing belt 20 in the circumferential direction of the fixing belt 20, the heater 22 is curved into an arc in cross section that corresponds to a curvature of the fixing belt 20. Other parts of the fixing device 9 illustrated in FIG. 32 are the same as the fixing device 9 illustrated in FIG. 31.

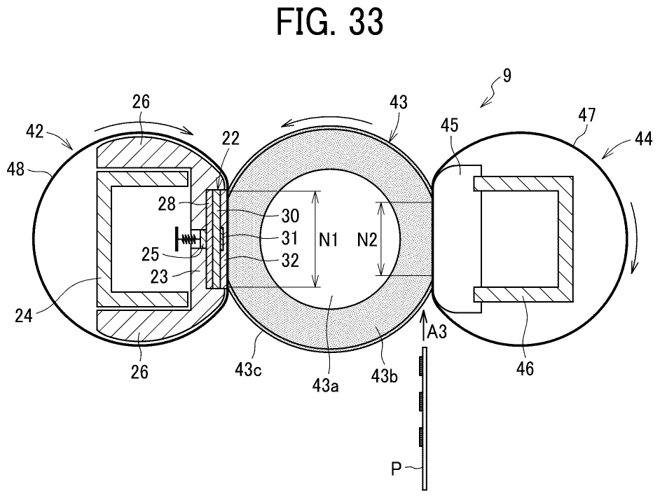

Lastly, the configuration of the fixing device 9 is described below, with reference to FIG. 33. The fixing device 9 includes a heating assembly 42, a fixing roller 43 that is a fixing member, and a pressure assembly 44 that is a counter member. The heating assembly 42 includes the heater 22, the first high-thermal conduction member 28, the heater holder 23, the stay 24, which are described in the above embodiments, and a heating belt 48 as a rotator. The fixing roller 43 is a counter rotator that rotates and faces the heating belt 48 as a rotator. The fixing roller 43 includes a core 43a, an elastic layer 43b, and a release layer 43c. The core 43a is a solid core made of iron. The elastic layer 43b coats the surface of the core 43a. The release layer 43c coats an outer circumferential face of the elastic layer 43b. The pressure assembly 44 is disposed opposite to the heating assembly 42 with respect to the fixing roller 43. The pressure assembly 44 includes a nip formation pad 45 and a stay 46 inside the loop of a pressure belt 47. The pressure belt 47 is rotatably arranged to wrap around the nip formation pad 45 and the stay 46. The sheet P passes through the fixing nip region N2 between the pressure belt 47 and the fixing roller 43 to be heated and pressed to fix the image onto the sheet P. The fixing roller 43 of the present embodiment is heated by contacting the heating belt 48 which is heated by the heater 22. In other words, the heater 22 indirectly heats the fixing roller 43 via the heating belt 48.

As described above, the embodiments of the present disclosure are also applicable to fixing devices as illustrated in FIGS. 31, 32, and 33, as described below. As a result, the arrangements may suppress sticking of deposits on the brush portion, which leads to further suppression of the performance reduction of the charge eliminating brush.

The image forming apparatus according to the present embodiments of the present disclosure is applicable not only to the color image forming apparatus illustrated in FIG. 1 but also to a monochrome image forming apparatus, a copier, a printer, a facsimile machine, or a multifunction peripheral including at least two functions of the copier, printer, and facsimile machine.

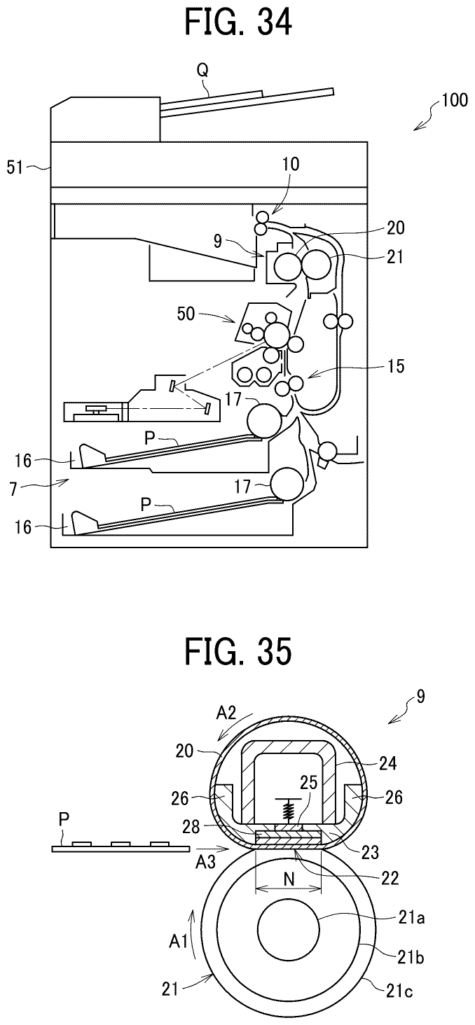

For example, as illustrated in FIG. 34, the image forming apparatus 100 according to the present embodiment includes an image forming device 50 including a photoconductor drum and the like, the sheet conveyer including the timing roller pair 15 and the like, the sheet feeder 7, the fixing device 9, the sheet ejection device 10, and a reading device 51. The sheet feeder 7 includes the plurality of sheet feeding trays which stores sheets of different sizes.

The reading device or scanner 51 reads an image of a document Q. The reading device 51 generates image data from the read image. The sheet feeder 7 stores the plurality of sheets P and feeds the sheet P to the conveyance path. The timing roller pair 15 conveys the sheet P on the conveyance path to the image forming device 50.

The image forming device 50 forms a toner image on the sheet P. Specifically, the image forming device 50 includes the photoconductor drum, a charging roller, the exposure device, the developing device, a supply device, a transfer roller, the cleaning device, and a discharging device. The toner image is, for example, an image of the document Q. The fixing device 9 heats and presses the toner image to fix the toner image on the sheet P. Conveyance rollers convey the sheet P on which the toner image has been fixed to the sheet ejection device 10. The sheet ejection device 10 ejects the sheet P to the outside of the image forming apparatus 100.

Next, the fixing device 9 of the present embodiment is described. Description of configurations common to those of the fixing devices of the above-described embodiments is omitted from the drawing as appropriate.

As illustrated in FIG. 35, the fixing device 9 includes the fixing belt 20, the pressure roller 21, the heater 22, the heater holder 23, the stay 24, the thermistors 25, and the first high thermal conduction member 28.

The fixing nip N is formed between the fixing belt 20 and the pressure roller 21. The nip width of the fixing nip N is 10 mm, and the linear velocity of the fixing device 9 is 240 mm/s.

The fixing belt 20 includes a polyimide base and the release layer and does not include the elastic layer. The release layer is made of a heat-resistant film material made of, for example, fluororesin. The outer loop diameter of the fixing belt 20 is about 24 mm.

The pressure roller 21 includes the core 21a, the elastic layer 21b, and the surface layer 21c. The pressure roller 21 has an outer diameter of 24 to 30 mm, and the elastic layer 21b has a thickness of 3 to 4 mm.

The heater 22 includes the base, the thermal insulation layer, the conductor layer including the resistive heat generator and the like, and the insulation layer, and is formed to have a thickness of 1 mm as a whole. The width Y of the heater 22 in the short-side direction is 13 mm.

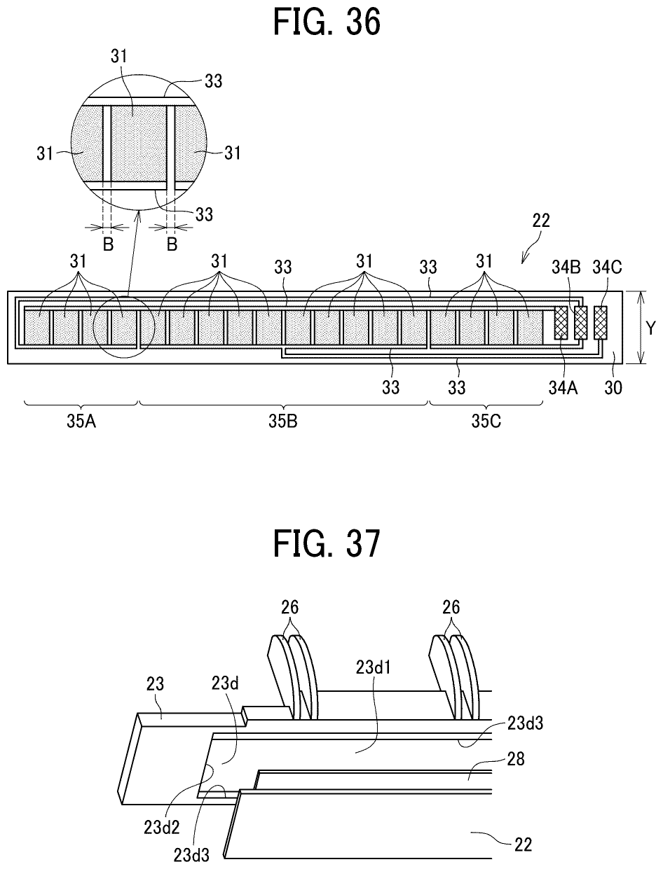

As illustrated in FIG. 36, the conductor layer of the heater 22 includes a plurality of resistive heat generators 31, power supply lines 33, and electrodes 34A to 34C. As illustrated in the enlarged view of FIG. 36, the separation area B is also formed in the present embodiment between neighboring resistive heat generators of the plurality of resistive heat generators 31 arranged in the longitudinal direction. The enlarged view of FIG. 30 illustrates two separation areas B, but the separation area B is formed between neighboring resistive heat generators of all the plurality of resistive heat generators 31. The resistive heat generators 31 configure three heat generation portions 35A to 35C. When a current flows between the electrodes 34A and 34B, the heat generation portions 35A and 35C generate heat. When a current flows between the electrodes 34A and 34C, the heat generation portion 35B generates heat. When the fixing device 9 fixes the toner image onto the small sheet, the heat generation portion 35B generates heat. When the fixing device 9 fixes the toner image onto the large sheet, all the heat generation portions 35A to 35C generate heat.

As illustrated in FIG. 37, the heater holder 23 holds the heater 22 and the first high thermal conduction member 28 in a recessed portion 23d. The recessed portion 23d is formed on the side of the heater holder 23 facing the heater 22. The recessed portion 23d has a bottom surface 23d1 and walls 23d2 and 23d3. The bottom surface 23d1 is substantially parallel to the base 30 and the surface recessed from the side of the heater holder 23 toward the stay 24. The walls 23d2 are both side surfaces of the recessed portion 23d in the longitudinal direction. The recessed portion 23d may have one wall 23d2. The walls 23d3 are both side surfaces of the recessed portion 23d in the short-side direction. The heater holder 23 has guide ribs 26. The heater holder 23 is made of LCP (Liquid Crystal Polymer).

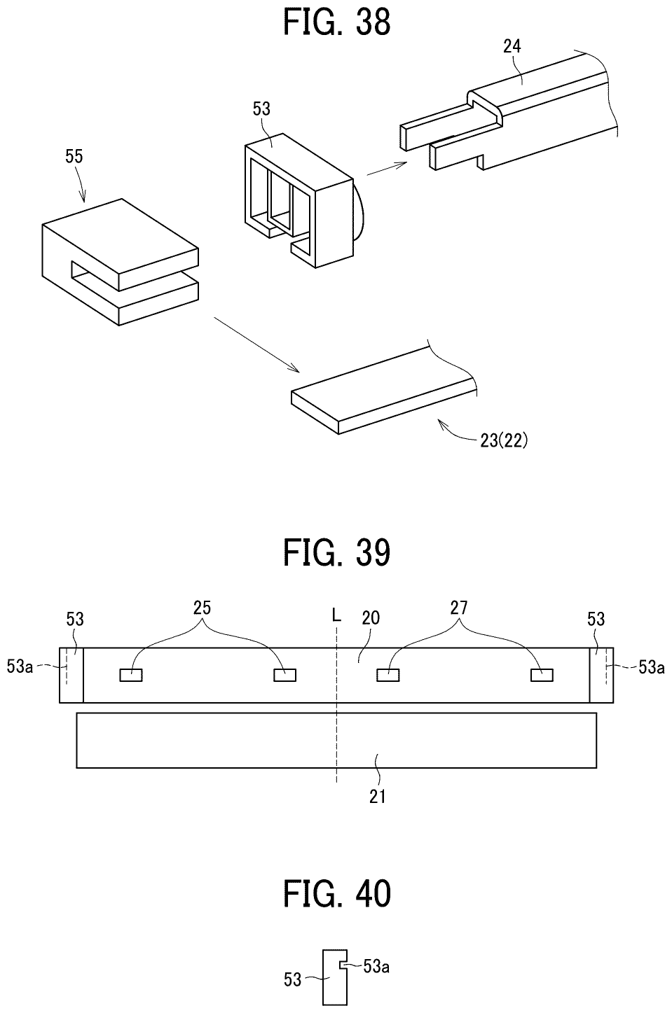

As illustrated in FIG. 38, a connector 55 includes a housing made of resin such as LCP and a plurality of contact terminals fixed to the housing.

The connector 55 is attached to the heater 22 and the heater holder 23 such that a front side of the heater 22 and the heater holder 23 and a back side of the heater 22 and the heater holder 23 are sandwiched by the connector 55. In this state, the contact terminals contact and press against the electrodes of the heater 22, respectively and the heat generation portions 35 are electrically coupled to the power supply provided in the image forming apparatus via the connector 55. The above-described configuration enables the power supply to supply power to the heat generation portions 35. Note that at least a part of each of the electrodes 34A to 34C is not coated by the insulation layer and therefore exposed to secure connection with the connector 55.

A flange 53 contacts the inner circumferential surface of the fixing belt 20 at each of both ends of the fixing belt 20 in the longitudinal direction to hold the fixing belt 20. The flange 53 is fixed to the housing of the fixing device 9. The flange 53 is inserted into each of both ends of the stay 24 (see an arrow direction from the flange 53 in FIG. 38).

To attach to the heater 22 and the heater holder 23, the connector 55 is moved in the short-side direction (see a direction indicated by an arrow from the connector 55 in FIG. 38). The connector 55 and the heater holder 23 may have a convex portion and a recessed portion to attach the connector 55 to the heater holder 23. The convex portion disposed on one of the connector 55 and the heater holder 23 is engaged with the recessed portion disposed on the other and relatively move in the recessed portion to attach the connector 55 to the heater holder 23. The connector 55 is attached to one end of the heater 22 and one end of the heater holder 23 in the longitudinal direction. The one end of the heater 22 and the one end of the heater holder 23 are farther from a portion in which the pressure roller 21 receives a driving force from a drive motor than the other end of the heater 22 and the other end of the heater holder 23, respectively.

As illustrated in FIG. 39, one thermistor 25 faces a center portion of the inner circumferential surface of the fixing belt 20 in the longitudinal direction, and another thermistor 25 faces an end portion of the inner circumferential surface of the fixing belt 20 in the longitudinal direction. The heater 22 is controlled based on the temperature of the center portion of the fixing belt 20 and the temperature of the end portion of the fixing belt 20 in the longitudinal direction that are detected by the thermistors 25.

As illustrated in FIG. 39, one thermostat 27, which is electrically coupled to the power supply and the heater 22 to mechanically cut off the power supplied to the heater 22 based on the temperature, faces a center portion of the inner circumferential surface of the fixing belt 20 in the longitudinal direction, and another thermostat 27 faces an end portion of the inner circumferential surface of the fixing belt 20 in the longitudinal direction. Each of the thermostats 27 shuts off a current to the heater 22 in response to a detection of a temperature of the fixing belt 20 higher than a predetermined threshold value.

Flanges 53 are disposed at both ends of the fixing belt 20 in the longitudinal direction and hold both ends of the fixing belt 20, respectively. The flange 53 is made of LCP.

As illustrated in FIG. 40, the flange 53 has a slide groove 53a. The slide groove 53a extends in a direction in which the fixing belt 20 moves toward and away from the pressure roller 21. An engaging portion of the housing of the fixing device 9 is engaged with the slide groove 53a. The relative movement of the engaging portion in the slide groove 53a enables the fixing belt 20 to move toward and away from the pressure roller 21.

The above mentioned charge eliminating brush, contact members (separation plate), and heaters et al. could also be adapted to the above fixing device 9. As a result, it may suppress the sticking of deposits on the brush portion, which leads to further suppression of the performance reduction of the charge eliminating brush.

The recording medium P may be a sheet of plain paper, thick paper, thin paper, a postcard, an envelope, coated paper, art paper, tracing paper, overhead projector (OHP) sheet, plastic film, prepreg, copper foil, or the like.

The heating device according to the present disclosures is not limited to the fixing device of the image forming apparatus as described above. In other words, the apparatus applicable to the present disclosure may be an image forming apparatus including a drying device to dry ink applied on a sheet, a laminator that thermally presses a film as a covered object to the surface of a sheet such as a paper, or other types of a heating device, for example, a thermocompression device such as a heat sealer that seals a sealing portion of a packaging material with heat and pressure. The above mentioned charge eliminating brush, contact members (separation plate), and heaters et al. could also be adapted to the above these apparatus. As a result, it may suppress the sticking of the deposit on the brush portion, which leads to further suppression of the performance reduction of the charge eliminating brush.

The configuration including, the conductive layer provided on the surface layer of the fixing belt and the pressure roller and the charge eliminating member contacts the conductive layer was described in the above explanation. However, the configuration according to the present disclosure is not limited to this configuration. It may be used to a configuration including at least a part of the surface layer of the fixing belt or the pressure roller includes a conductive layer and the charge eliminating member contacts the conductive layer. For example, only a part of an inner conductive layer of the fixing belt or the pressure roller may be exposed to the outside at a portion corresponding to the part.

The configuration including the separating member which separate sheet from the fixing member or the pressure member performs as the contact member was explained as the example in the above explanation. For example, the contact member may be a contact-type temperature detection member such as a thermistor, or a new contact member may be separately provided. By using the separating member as the contact member, it is not necessary to provide a new member separately, and the number of parts of the fixing device can be reduced. In addition, the separating member is not limited to the shape of the separation plate 40 and the separation claw 68 described above. Further, the fixing device 9 of FIG. 2 may be provided with the separation claw 68 of FIG. 15, or may be provided with the static elimination needle 70 instead of the charge eliminating brush 37. Conversely, the charge eliminating brush 37 may be disposed in the fixing device 9 of FIG. 15.

Aspects of the present disclosure are, for example, as follows.

Aspect 1. A heating device (9) comprising:
a rotator (20);
a heater (22) including a main heat generating region (D) configured to heat the rotator (20);
a pressurizer (21) including a conductive surface configured to contact the rotator (20) to form a nip (N) therebetween;
a charge eliminator (37);
a contact part (40c) configured to contact the rotator (20);
wherein the charge eliminator (37) contacts to the conductive surface at a portion (E) of the pressurizer (21), the portion being outside of the main heat generating region (D) in a longitudinal direction of the heater (22); and
wherein the contact part (40c) contacts to the rotator (20) at a position corresponding to the portion (E) in a longitudinal direction of the heater (22).

Aspect 2. The heating device according to aspect 1, further including
a maximum medium passage region,
wherein the charge eliminator (37) contacts the pressurizer (21) at outside region of the maximum medium (P) passage region in the longitudinal direction of the heater (X).

Aspect 3. The heating device according to aspect 1 or 2, further includes
a separator (40) including separation portion (40b), arranged to face downstream of the rotator (20) in a rotation direction of the rotator (A2), configured to separate the medium from the rotator (20), wherein
the contact part (40c) is a part of the separator (40),
the contact part (40c) contacts to the rotator (20) such that a gap is created between the separation portion (40b) and the rotator (20).

Aspect 4. The heating device according to aspect 1, 2, or 3, wherein
the contact part (40c) includes a first portion contacts to the rotator (20) and a second portion contacts to the rotator (20);
the second portion is wider than the first portion in the longitudinal direction of the heater (X);
the second portion is downstream of the first portion in a rotation direction of the rotator (A2).

Aspect 5. The heating device according to aspect 1,2,3, or 4 wherein
the contact part (40c) includes a contact surface inclined to a rotation direction of the rotator (A2).

Aspect 6. A heating device (9) comprising:
a rotator (20) including a conductive surface;
a heater (22) configured to heat the rotator (20);
a pressurizer (21) configured to contact the rotator (20) to form a nip (N) therebetween;
a charge eliminator (37) configured to contact the conductive surface;
a separator (40) including a contact part (40c), the contact part (40c) contacts the rotator (20);
wherein the charge eliminator (37) contacts to the conductive surface at a portion (E) of the rotator (20), and
wherein the contact part (40c) contacts to the rotator (20) at a position corresponding to the portion (E) in a longitudinal direction of the heater (22).

Aspect 7. The heating device according to aspect 6, wherein
the heater (22) includes a main heat generating region (D) configured to heat the rotator (20),
the separator (40) includes a pair of the contact parts (40c) to contact each end portion of the rotator (20) in the longitudinal direction of the heater (22),
a gap between the separation portion (40b) and the rotator (20) is created between the pair of the contact parts (40c),
the charge eliminator (37) contacts to the conductive surface at outside of the main heat generating region (D).

Aspect 8. A heating device (9) comprising:
a rotator (20);
a heater (22) including a main heat generating region (D) configured to heat the rotator (20);
a pressurizer (21) including a conductive surface;
a charge eliminator (37) configured to contact the conductive surface;
a separator (40) including a pair of contact parts (40c), each of the pair of contact parts (40c) being arranged at each end of a longitudinal direction of a rotator (20), the pair of contact parts (40c) contacts to the pressurizer (21) such that a gap is created between the separation portion (40b) and the rotator (20) at between the pair of contact parts (40c);
wherein the charge eliminator (37) contacts to the conductive surface at a portion (E) of the pressurizer (21), the portion being outside of the main heat generating region (D) in the longitudinal direction of the rotator (20); and
wherein the pair of contact parts (40c) contacts to the pressurizer (21) at a position corresponding to the portion (E) in the longitudinal direction of the rotator (20).

Aspect 9. A fixing device to fix a toner on a medium including
the heating device according to either one of aspect 1 to 8.

Aspect 10. An image forming apparatus comprising,
the fixing device according to aspect 9.

Aspect 11. The image forming apparatus according to aspect 10 wherein
the image forming apparatus has an ability to print to the plurality of size of a medium including a first size and a maximum size, the first size is smaller than the maximum size,
the image forming apparatus configured to fix toner on the medium of the first size with a first interval between each medium of the first size to be printed,
the image forming apparatus configured to fix toner on the medium of the maximum size with a second interval between each medium of the maximum size to be printed,
wherein the first interval is longer than the second interval.

Aspect 12. The image forming apparatus according to aspect 11 wherein
when printing the first size continuously, the first interval of latter print is longer than the first interval of previous print.

Aspect 13. The image forming apparatus according to aspect 10 wherein
when printing on to a coated medium continuously, an interval for the coated medium is longer than an interval for other medium.

Aspect 14. An drier comprising,
the heating device according to either one of aspect 1 to 8.

Aspect 15. An ink jet image forming apparatus comprising,
the drier according to either one of aspect 1 to 8.

Aspect 16. A laminate processing apparatus comprising,
the heating device according to either one of aspect 1 to 8.

Aspect 17. The heating device according to either one of aspect 1 to 8, wherein
the heater (22) includes an induction heater (63),
the pressurizer (21) includes a pressure roller (62),
the rotator (20) includes a fixing belt (61).

Aspect 18. The heating device according to either one of aspect 1 to 8, wherein
the heater (22) includes resistive heat generator (31) on a base (30),
the pressurizer (21) includes a pressure roller (62),
the rotator (20) includes a fixing belt (61).

What is claimed is:

1. A heating device, comprising:
a rotator;
a heater including a main heat generating region to heat the rotator;
a pressurizer including a conductive surface to contact the rotator to form a nip therebetween;
a charge eliminator;
a contact part to contact the rotator;
wherein the charge eliminator contacts to the conductive surface at a portion of the pressurizer, the portion being outside of the main heat generating region in a longitudinal direction of the heater; and
wherein the contact part contacts to the rotator at a position corresponding to the portion in the longitudinal direction of the heater.

2. The heating device according to claim 1, further comprising:
a maximum medium passage region,
wherein the charge eliminator contacts the pressurizer at a region which is outside of the region of the maximum medium passage region in the longitudinal direction of the heater.

3. The heating device according to claim 1, further comprising:
a separator including separation portion, arranged to face downstream of the rotator in a rotation direction of the rotator, to separate a medium from the rotator,
wherein:
the contact part is a part of the separator,
the contact part contacts to the rotator such that a gap is created between the separation portion and the rotator.

4. The heating device according to claim 1, wherein:
the contact part includes a first portion that contacts the rotator and a second portion that contacts the rotator;
the second portion is wider than the first portion in the longitudinal direction of the heater;
the second portion is downstream of the first portion in a rotation direction of the rotator.

5. The heating device according to claim 1, wherein:
the contact part includes a contact surface inclined to a rotation direction of the rotator.

6. A heating device, comprising:
a rotator including a conductive surface;
a heater to heat the rotator;
a pressurizer to contact the rotator to form a nip therebetween;
a charge eliminator to contact the conductive surface;
a separator including a contact part, the contact part contacts the rotator;
wherein the charge eliminator contacts to the conductive surface at a portion of the rotator, and
wherein the contact part contacts to the rotator at a position corresponding to the portion in a longitudinal direction of the heater.

7. The heating device according to claim 6, wherein:
the heater includes a main heat generating region to heat the rotator,
the separator includes a pair of the contact parts to contact each end portion of the rotator in the longitudinal direction of the heater,
a gap between a separation portion and the rotator exists between the pair of the contact parts,
the charge eliminator contacts to the conductive surface at outside of the main heat generating region.

8. A heating device, comprising:
a rotator;
a heater including a main heat generating region to heat the rotator;
a pressurizer including a conductive surface;
a charge eliminator to contact the conductive surface;
a separator including a pair of contact parts, each of the pair of contact parts being arranged at each end of a longitudinal direction of a rotator, the pair of contact parts contacts to the pressurizer such that a gap is created between the separator and the rotator at between the pair of contact parts;
wherein the charge eliminator contacts to the conductive surface at a portion of the pressurizer, the portion being outside of the main heat generating region in the longitudinal direction of the rotator; and
wherein the pair of contact parts contacts to the pressurizer at a position corresponding to the portion in the longitudinal direction of the rotator.

9. A fixing device to fix a toner on a medium, comprising:
the heating device according to claim 1.

10. An image forming apparatus, comprising:
the fixing device according to claim 9.

11. The image forming apparatus according to claim 10, wherein:
the image forming apparatus has an ability to print to a plurality of sizes of a medium including a first size and a maximum size, the first size is smaller than the maximum size,
the image forming apparatus is configured to fix toner on the medium of the first size with a first interval between each medium of the first size to be printed,
the image forming apparatus is configured to fix toner on the medium of the maximum size with a second interval between each medium of the maximum size to be printed, and
wherein the first interval is longer than the second interval.

12. The image forming apparatus according to claim 11, wherein:
when printing the first size continuously, the first interval of a latter print is longer than the first interval of a previous print.

13. The image forming apparatus according to claim 10 wherein:
when printing on to a coated medium continuously, an interval for the coated medium is longer than an interval for other medium.

14. A drier, comprising:
the heating device according to claim 1.

15. An ink jet image forming apparatus, comprising:
the drier according to claim 14.

16. A laminate processing apparatus, comprising:
the heating device according to claim 1.

17. The heating device according to claim 6, wherein:
the heater includes an induction heater,
the pressurizer includes a pressure roller, and
the rotator includes a fixing belt.

18. The heating device according to claim 1, wherein:
the heater includes resistive heat generator on a base,
the pressurizer includes a pressure roller, and
the rotator includes a fixing belt.

19. The heating device according to claim 6, wherein:
the heater includes resistive heat generator on a base,
the pressurizer includes a pressure roller, and
the rotator includes a fixing belt.

20. The heating device according to claim 8, wherein:
the heater includes resistive heat generator on a base,
the pressurizer includes a pressure roller, and
the rotator includes a fixing belt.
